(19) United States
(12) Patent Application Publication
(10) Pub. No.: US 2016/0098670 A1
(43) Pub. Date: Apr. 7, 2016

(54) Technological and Financial Partnerships to Enable a Package Exchange Service

(71) Applicant: Continental Intelligent Transportation Systems, LLC, Santa Clara, CA (US)

(72) Inventors: Seval Oz, San Jose, CA (US); Tammer Zein El-Abedein, Campbell, CA (US); Yao Shi, Mountain View, CA (US); Ritesh Ahuja, Cupertino, CA (US); Anabel Gallardo Bojorquez, Arlington Heights, IL (US); Dan Treuz, Chicago, IL (US)

(21) Appl. No.: 14/826,649

(22) Filed: Aug. 14, 2015

Related U.S. Application Data
(60) Provisional application No. 62/058,410, filed on Oct. 1, 2014.

(51) Int. Cl. G06Q 10/08; G06Q 30/06

(52) U.S. Cl. CPC G06Q 10/083; G06Q 30/0641

(57) ABSTRACT

A cloud based package transfer system is discussed that has a cloud based package-exchange-service hosted on a cloud based provider site. The cloud based package-exchange-service supplies servers and databases of retail websites with information regarding services for package exchange available to customers and their associated vehicles. The information enables a retail website to present a checkbox, the presented checkbox enables a customer at a checkout point of the purchase from the retail website to select an alternative package delivery option of delivering the purchased products to a target vehicle of the customer. The package-exchange-service receives purchase information from the retail websites and use purchase information to create database records for completed delivery operations. The package-exchange-service sets up the package delivery operation and implements a financial model that use the database records to calculate financial transactions between the package-exchange-service and the retail websites.

### RELATED APPLICATIONS

This application claims the benefit of U.S. Provisional Patent Application No. 62/058,410, filed Oct. 1, 2014, and entitled “PACKAGE DELIVERY TO AND PICK-UP FROM A VEHICLE” and is incorporated herein by reference.

### FIELD

The design generally relates to a package delivery to and pick-up from a vehicle system.

### BACKGROUND

Typically, shipments are usually sent to the home address of the person concerned. This technology instead delivers packages to or picks-up a package inside a customer's vehicle while ensuring safe delivery at the exchange location.

### SUMMARY

In general, a cloud based package-exchange-with-a-vehicle service is hosted on a cloud based provider site that includes one or more servers each having one or more processors. The one or more servers are configured to store and retrieve information with one or more databases in the cloud based provider site. One or more of the servers of the cloud based package-exchange-with-a-vehicle service are configured to supply servers and databases of one or more retail websites with information regarding services for a package exchange available to one or more customers and associated vehicles of the customers. A first module in a first server associated with the package-exchange-with-a-vehicle service is configured to provide the information regarding the services for a package exchange with a vehicle of a customer to a second server of a first retail website. The information regarding services includes one or more package delivery systems with their servers that are set up to cooperate with the servers of the package-exchange-with-a-vehicle service to deliver one or more purchased products from the first retail website to an associated target vehicle of the customer. The information regarding services which is sent from the first server of the package-exchange-with-a-vehicle service to the second server of the first retail website enables the first retail website to present a button on a user interface of a shopping application resident on a first client device of the customer. The first client device is coupled to the first retail website for purchasing products from the first retail website. The presented button is configured to enable the customer at a checkout point of the purchase from the first retail website, to select an alternative package delivery option of delivering the one or more purchased products to the associated target vehicle of the customer. A shipping and tracking module in the first server associated with the package-exchange-with-a-vehicle service is configured to communicate with the second server of the first retail website to receive purchase information after the checkout point and completion of the purchase by the customer, the purchase information includes information regarding the customer including their name, and the target vehicle of the customer, at least a first package delivery system that is set up to exchange the purchased products with the target vehicle of the customer, and an expected delivery date and delivery location. The purchase information is stored in the one or more databases in the cloud based provider site. The shipping and tracking module is configured to cooperate with at least a first database and a first processor of the cloud based provider site to process information including a shipping Tracking Number (TN) and a Vehicle Identification Number (VIN) of the target vehicle associated with the purchase and to register the purchase information and a request for package delivery to the target vehicle of the customer in one of the databases of the cloud based provider site associated with the package-exchange-with-a-vehicle service. A security module in the first server associated with the package-exchange-with-a-vehicle service is configured to setup a package delivery operation including 1) a first routine to direct delivery of the one or more purchased products to the associated target vehicle of the customer, 2) a second routine to open and/or unlock the target vehicle of the customer to ensure the one or more purchased products can be delivered, 3) a third routine to ensure the one or more purchased products have been delivered, and 4) a forth routine to ensure, after delivery of the purchased products, the target vehicle of the customer is closed and locked. A compensation module in one of the servers of the package-exchange-with-a-vehicle service is configured to implement a first financial model from two or more financial models stored in the first database, the first financial model uses the database records to track and calculate financial transactions between the package-exchange-with-a-vehicle service and the one or more retail websites. The cloud based package-exchange-with-a-vehicle service can be implemented in software, hardware electronics, and any combination of both, and when one or more portions of the package-exchange-with-a-vehicle service including portions of the modules are implemented in software then the software is tangibly stored in an executable format on one or more non-transitory storage mediums and executed by at least one of the processors.

In an embodiment, a method to facilitate a package exchange with a vehicle via a cloud based package-exchange-with-a-vehicle service is described. The cloud based package-exchange-with-a-vehicle service is hosted on a cloud based provider site that includes one or more servers each having one or more processors, where the servers store and retrieve information with one or more databases of the cloud based provider site. The servers of the cloud based package-exchange-with-a-vehicle service are configured to provide servers and databases of one or more retail websites with information regarding services for a package exchange available to one or more customers and associated vehicles of the customers. A first module in a first server associated with the package-exchange-with-a-vehicle service provides the information regarding the services for package exchange with a vehicle of a customer to a second server of a first retail website. The information includes one or more package delivery systems that can deliver purchased products from the first retail website to an associated target vehicle of the customer. The first retail website is enabled to present a button on a user interface of a shopping application resident on a first client device of the customer. The first client device is coupled to the first retail website for purchasing products from the first retail website, the button enables the customer at a checkout point of the purchase from the first retail website, to select an alternative package delivery option of delivering the purchased products to the associated target vehicle of the customer. A shipping and tracking module in the first server associated with the package-exchange-with-a-vehicle service receives purchase information after a checkout point and completion of the purchase by the customer when at the checkout point the customer selects the button for an alternative package delivery option to the associated target vehicle of the customer. The purchase information includes information of the customer and the target vehicle of the customer, at least a first package delivery system, a shipping Tracking Number (TN), a Vehicle Identification Number (VIN) associated with the purchase, and an expected delivery date and an expected delivery location. The shipping and tracking module processes and registers the purchase information including a request for package delivery to the target vehicle of the customer. The purchase information is registered in a first database of the cloud based provider site associated with the package-exchange-with-a-vehicle service. A package delivery operation is set up by a security module in the first server associated with the package-exchange-with-a-vehicle service. The package delivery operation includes 1) delivery of the purchased products to the target vehicle of the customer, 2) opening and/or unlocking the target vehicle of the customer to ensure the one or more purchased products can be delivered, 3) ensuring the one or more purchased products have been delivered, and 4) after delivery, ensuring the target vehicle of the customer is closed and locked and delivery is complete. A fourth module in the first server associated with the package-exchange-with-a-vehicle service creates one or more database records for each completed delivery operation and stores the database records in the first database to keep track of deliveries. The shipping and tracking module sends a notice of package exchange to any of i) the second server of the first retail website, ii) the first client device of the customer, and iii) any combination of both. A first financial model is implemented on the database records by a compensation module in the first server associated with the package-exchange-with-a-vehicle service. The first financial model is selected from one or more financial models stored in the first database to calculate financial transactions between the package-exchange-with-a-vehicle service and the one or more retail websites. The package-exchange-with-a-vehicle service may be implemented in software, hardware electronics, and any combination of both, and when one or more portions of the package exchange system including portions of the modules are implemented in software, and any software implemented on the first client device, then the software is tangibly stored in an executable format on one or more non-transitory storage mediums.

In an embodiment, a security system is used by a cloud-based package-exchange-with-a-vehicle service to coordinate a secure package exchange. One or more servers, each having one or more processors, one or more ports, and are configured to cooperate with one or more databases in the system for cloud based package-exchange-with-a-vehicle service. A security module running on the one or more processors is configured to coordinate the secure package exchange with an access module in a target vehicle by either directly sending an access control sequence and authentication code to a receiver module in a client device or sending an executable software package to be locally calculated by a processor on a client device to generate an appropriate access control sequence and authentication code to access the specific target vehicle associated with a first user for the package exchange by remotely opening up or unlocking up the target vehicle. The security module is configured to receive, via one of the ports, a notification of a package exchange request for the first user either i) from a server of a first package delivery system or ii) from a server of a first merchant site. The security module is configured via a first port to receive credentials of the first user corresponding to an account of the first user stored in a database of the package-exchange-with-a-vehicle service and configured to verify the first user based on the credentials of the first user including a username, a password, and zero or more security questions. After the verification, the security module is configured to send, via one of the ports, a verification response i) to the server of the first package delivery system, ii) to the server of the first merchant site, or iii) both. After the verification, the security module is configured to look up in the database in the cloud-based package-exchange-with-a-vehicle service for one or more contact information listings for the first user. A first routine then is coded to create one or more notifications, including any of e-mail notifications, SMS text notifications, and mobile app notifications, to one or more client devices associated with the first user. The one or more notifications request the first user to take action to verify that a package exchange with their target vehicle has indeed been requested by that first user. A second routine in the security module is configured to, when there is more than one vehicle associated with the account of the first user, via one of the ports, to receive confirmation of which one of the vehicles associated with the account of the first user will be the target vehicle used for the package exchange with the first package delivery system, the received confirmation is from any of the following i) the client device of the user, ii) the server of the first merchant site, and iii) the server of the first package delivery system. A first module in one of the servers associated with the package-exchange-with-a-vehicle service is configured to provide information regarding the services for a package exchange with a vehicle of a potential customer to the server of first merchant site prior to any purchase of a product. The information regarding the services sent prior to any purchase of a product, is sent from the first server of the package-exchange-with-a-vehicle service, via one of the ports, to the server of the first merchant site to enable the first merchant site to present a button on a user interface of a shopping application resident on a first client device of the customer. The first client device is coupled to the first merchant website for purchasing products from the first merchant website. The presented button is configured to enable the customer at a checkout point of the purchase from the first merchant site, to select an alternative package delivery option of delivering the one or more purchased products to the associated target vehicle of the customer. A shipping and tracking module in the first server associated with the package-exchange-with-a-vehicle service is configured to communicate with the server of the first merchant site to receive purchase information after the checkout point and completion of the purchase by the customer. A compensation module in one of the servers of the package-exchange-with-a-vehicle service is configured to implement a first financial model from two or more financial models stored in the first database. The first financial model uses the database records to track and calculate financial transactions between the package-exchange-with-a-vehicle service and the one or more merchant websites. The shipping and tracking module is configured to cooperate with the security module to set up the secure package exchange operation. The compensation module is configured to implement one or more of the financial models that use database records from the package-exchange-with-a-vehicle service to calculate financial transactions between the package-exchange-with-a-vehicle service and the merchant sites.

In an embodiment, a method for an alternative package pickup and delivery system includes a number of example steps. The consumer while shopping at a retail store, at checkout, can purchase one or more selected products on a retail website. The consumer is offered on the user interface at checkout an alternative package delivery option to have the purchased products delivered to a vehicle using a cloud-based package-exchange-with-a-vehicle service. The consumer selects the delivery method offered on the user interface labeled as “Box2Go Delivery,” to have the package delivered to the consumer's vehicle. The package-exchange-with-a-vehicle service processes the alternative package pickup and delivery option. The purchased products are delivered to the consumer's vehicle's location. The package-exchange-with-a-vehicle service opens the consumer's vehicle and ensures the purchased products have been delivered. The package-exchange-with-a-vehicle service ensures the consumer's vehicle is closed and locked when the purchased products have been delivered.

### BRIEF DESCRIPTION OF THE DRAWINGS

The multiple drawings refer to the example embodiments of the design.

FIG. 1 illustrates a block diagram of an example computing system that may be used in an embodiment of one or more of the servers, in-vehicle electronic modules, and client devices discussed herein.

FIGS. 2A-2B illustrate block diagrams of embodiments of the package-exchange-with-a-vehicle service hosted on a cloud-based provider site.

FIGS. 3A-3C illustrate block and flow diagrams of an embodiment of the alternative delivery system using a telematics solution.

FIG. 4 illustrates a flow diagram of an embodiment of the alternative package pickup and delivery system using an example Dongle solution.

FIG. 5 illustrates an example class diagram of an embodiment of an application programming interface for the alternative package pickup and delivery system.

FIGS. 6A-6B illustrate flow diagrams of embodiment of the alternative delivery system.

FIGS. 7A and 7B illustrate block and flow diagrams of embodiments of the GPS-based control and tracking mechanisms used for delivery to or pick-up from the vehicle.

FIGS. 8A-8D illustrate block and flow diagrams of embodiment of the value proposition of the alternative delivery system and a compensation module in one of the servers of the package-exchange-with-a-vehicle service.

FIGS. 9A-9D illustrate block diagrams of embodiments of the multiple paired virtual keys and security authorization notices used by the package-exchange-with-a-vehicle service.

FIG. 10 illustrates a sequence diagram of embodiment of a package pick up from a user of the package-exchange-with-a-vehicle service.

FIG. 11 illustrates a block diagram overview of an embodiment of the package-exchange-with-a-vehicle service hosted on a cloud-based and some of its features including i) process connectivity to multiple platforms, ii) built in privacy and security, and iii) a vehicle awake and alert system via proximity.

FIG. 12 illustrates a flow graph of an example method for package-exchange-service between a package delivery vehicle and a target vehicle of a customer.

FIG. 13 illustrates diagrams of an application of a package exchange service with a vehicle on a client device used to coordinate a secure package exchange.

FIG. 14 illustrates a block diagram of an example merchant site presenting a button on a user interface of a shopping application resident on the client device of the customer.

FIGS. 15-17 illustrate diagrams of an application of a package exchange service with a vehicle on a client device used to coordinate a secure package exchange for packages from a plurality of merchant sites.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific package delivery services, named components, connections, number of databases, etc., in order to provide a thorough understanding of the present design. It will be apparent; however, to one skilled in the art that the present design may be practiced without these specific details. In other instances, well known components or methods have not been described in detail but rather in a block diagram in order to avoid unnecessarily obscuring the present design. Thus, the specific details set forth are merely exemplary. The specific details discussed in one embodiment may be reasonably implemented in another embodiment. The specific details may be varied from and still be contemplated to be within the spirit and scope of the present design.

In general, the package exchange (i.e., delivery to and pick-up from) with a vehicle service facilitates package delivery or pick up from a vehicle at home, at work or virtually anywhere. The package-exchange-with-a-vehicle service may be hosted on a cloud-based provider site. The package-exchange-with-a-vehicle service hosted on a cloud-based provider site may use an onboard actuation module for commanding the vehicle such as locking and unlocking the vehicle. The package-exchange-with-a-vehicle service may use an already existing access module installed in the vehicle such as the onboard RF access module, a telematics module, or may install a dongle as the access module. If the telematics system is used, the package-exchange-with-a-vehicle service can receive data such as GPS coordinates of the vehicle from the telematics module of the vehicle or can send command to the telematics module of the vehicle through the telematics provider. Alternatively, the package-exchange-with-a-vehicle service can use a dongle module having a WiFi or cellular communication circuit configured to establish a secure communication between the vehicle and the cloud based server associated with the package-exchange-with-a-vehicle service. The dongle can be coupled to an electro-mechanical activation circuit configured to cooperate with a fault and diagnostic module installed in the target vehicle of the customer to retrieve diagnostic data including the GPS coordinates of the vehicle of the user. The dongle can also implement RF circuitry and to operate like a key fob. Alternatively, the package-exchange-with-a-vehicle service can use a local client device, such as a smart phone or deliver person's hand held device, having a WiFi or cellular communication circuit configured to establish a secure communication between the local device and the cloud based server associated with the package-exchange-with-a-vehicle service. The local client device also then has a radio frequency transceiver module to establish secure communications with the access module in the vehicle and the local device. Additionally, when no actuation module installed in the vehicle is capable of supplying the GPS coordinates of the vehicle, the package-exchange-with-a-vehicle service can receive the GPS coordinates of the vehicle from a client device (e.g., a mobile phone) of the user. The package-exchange-with-a-vehicle service can supply the smart phone or deliver person's hand held device acting as a universal key fob simulator to implement the appropriate sequence of radio frequencies and protocol challenges and responses to the access module installed in the vehicle. The package-exchange-with-a-vehicle service can implement financial models to calculate financial transactions between the package-exchange-with-a-vehicle service and either i) the merchant websites, ii) the package delivery systems, and/or iii) telematics providers.

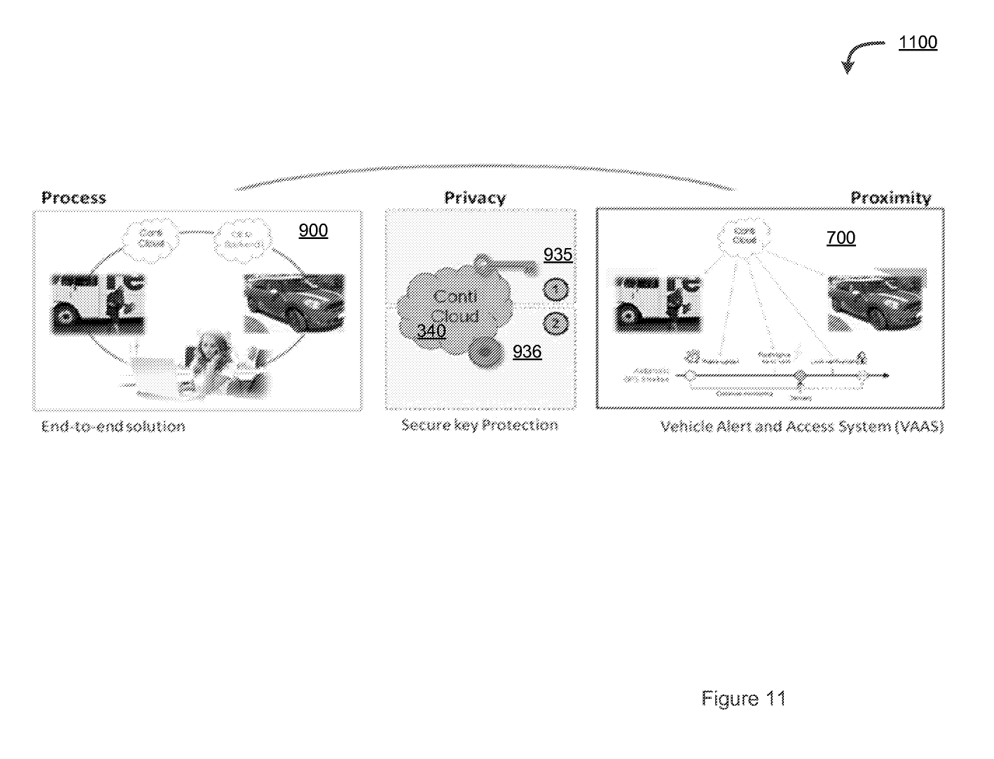

The package-exchange-with-a-vehicle service can use two or more paired-virtual keys, such as a dual-key protection mechanism, via secure key matching authentication in order to render hacking any single system's server useless. Additionally, the virtual keys are given a shelf life to limit authorized package delivery and subsequent activation of the vehicle's onboard actuation module to within a specified time window. If the telematics system is used, the package-exchange-with-a-vehicle service may not store the user credentials for the OEM telematics systems in its databases and, in general, only encrypted data is transmitted from the cloud-based package-exchange-with-a-vehicle service and i) the applications resident on client devices, ii) the package delivery systems, and iii) the OEM telematics systems. The package-exchange-with-a-vehicle service uses a GPS-based proximity system to control and track the package exchange process, to speed up the package delivery and pick-up process, and to ensure security for the package exchange. The package-exchange-with-a-vehicle service also uses a mobile delivery notice to verify the origination of the package delivery order as well as to communicate a successful delivery or pick up of a package. The package-exchange-with-a-vehicle service picks up or delivers a package to wherever vehicle is parked, including the service can deliver package to or pick-up package from a rental car while on business trip. (See FIG. 11 for a block diagram overview of an embodiment of the package-exchange-with-a-vehicle service hosted on a cloud-based and some of its features including i) process connectivity to multiple platforms, ii) built in privacy and security, and iii) a vehicle awake and alert system via proximity).

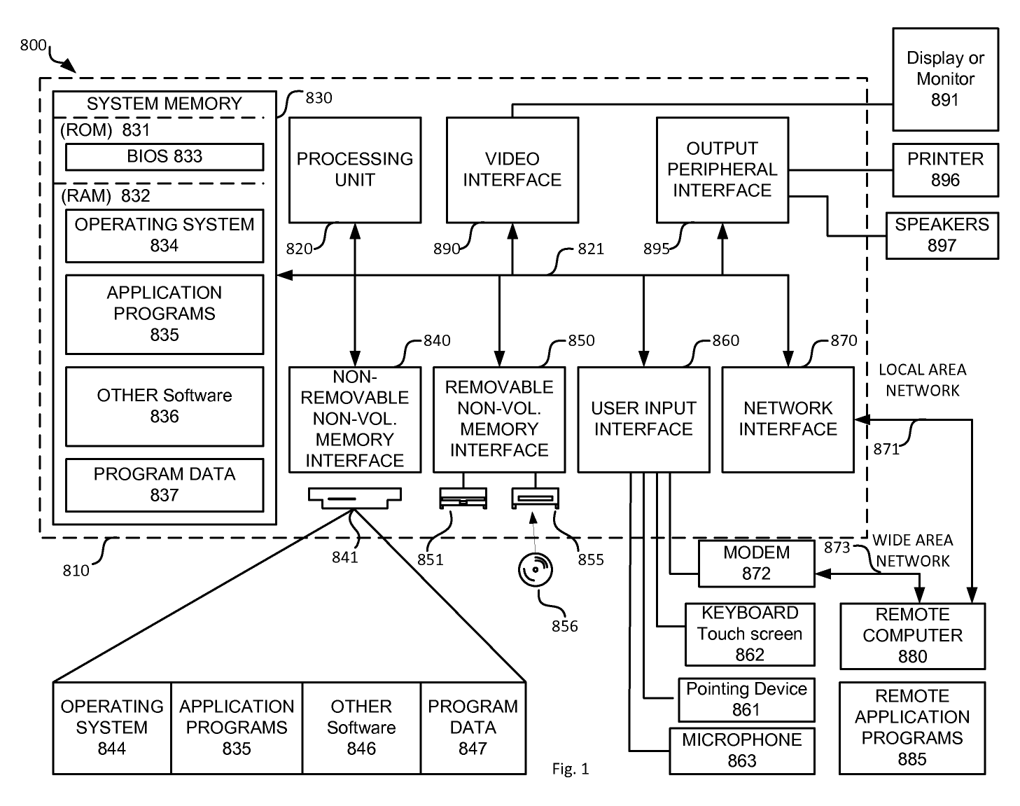

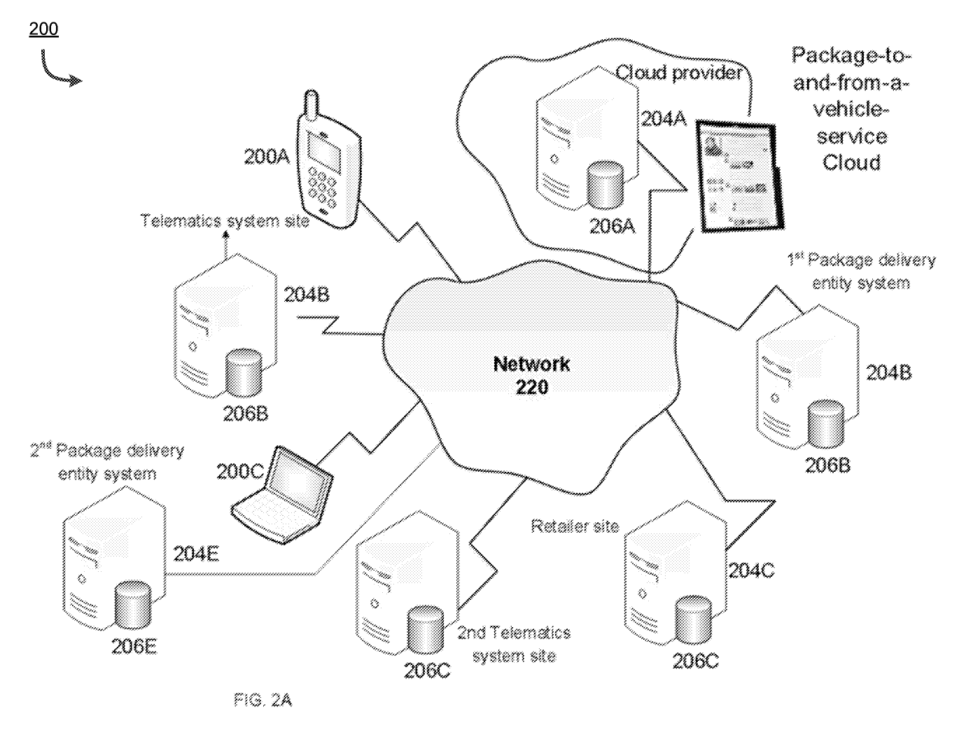

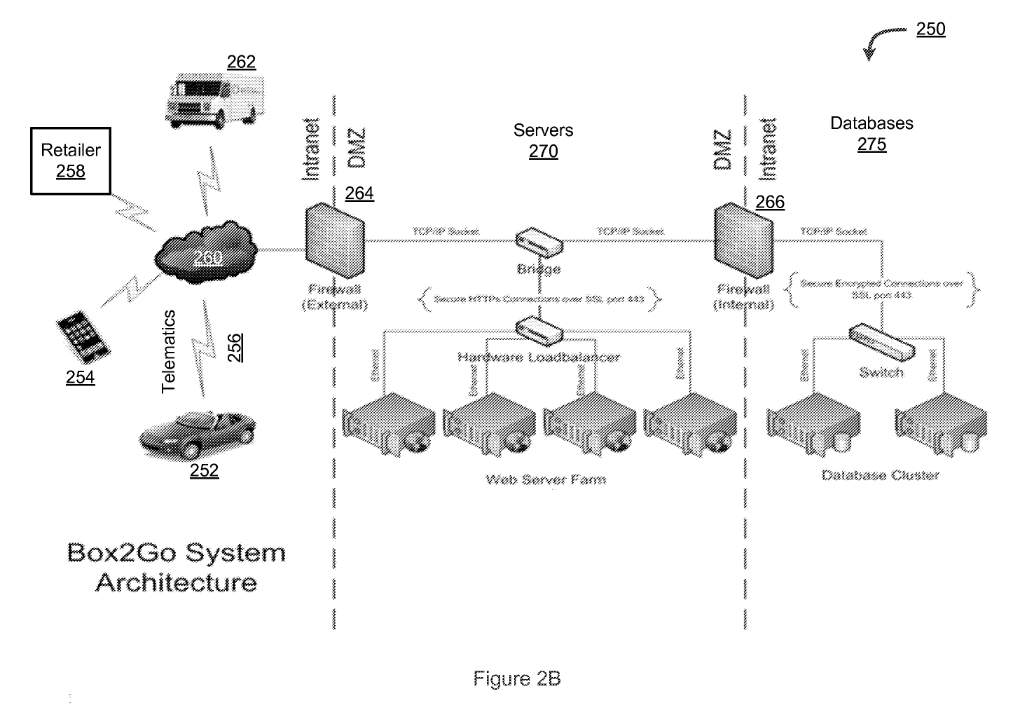

Example processes for and apparatuses to provide an automated process workflow for the entire cloud-based package-exchange-with-a-vehicle service are described. The following drawings and text describe various example implementations of the design. FIG. 1 and FIGS. 2A-2B illustrate example environments to implement the concepts.

The cloud-based package-to-and-from-the-vehicle-service cloud system can be implemented in software, hardware electronics, and any combination of both and when one or more portions of the system are implemented in software, then that software is tangibly stored in an executable format on the one or more non-transitory storage mediums to be executed by a processing component.

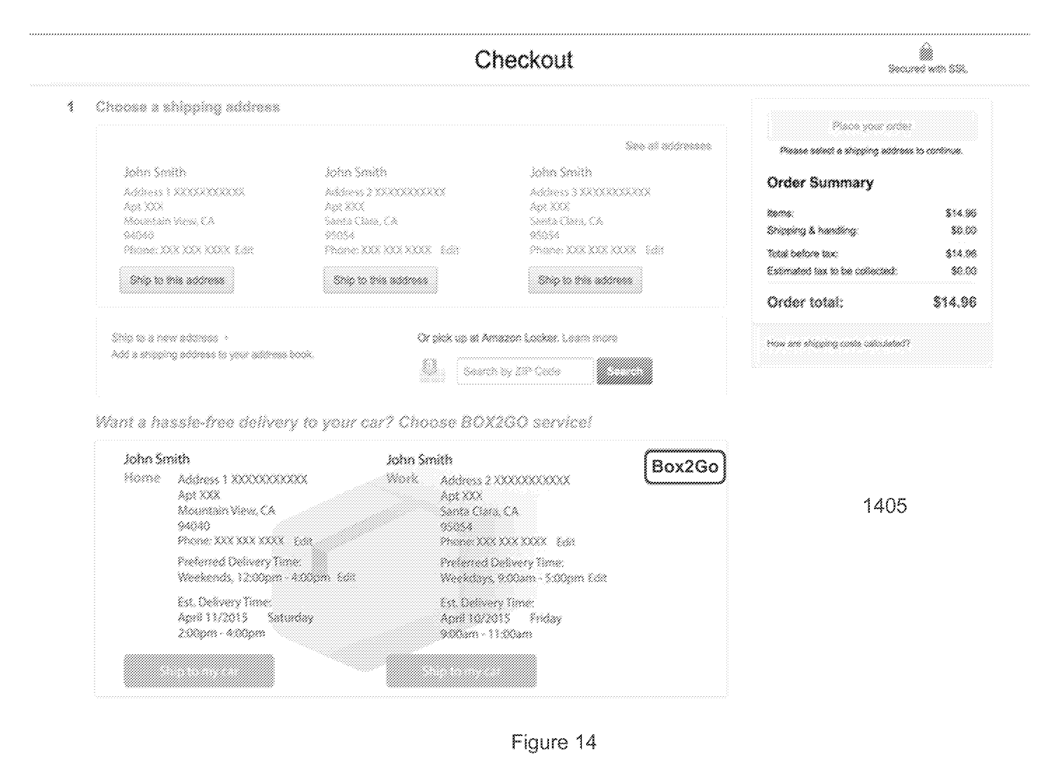

FIG. 14 illustrates a block diagram of an example merchant site presenting a button on a user interface of a shopping application resident on the client device of the customer. The cloud based package-exchange-with-a-vehicle service cooperates with multiple merchant sites. One or more of the servers of the cloud based package-exchange-with-a-vehicle service are configured to supply servers and databases of one or more retail websites with information regarding services for a package exchange available to one or more customers and associated vehicles of the customers. A module in a server associated with the package-exchange-with-a-vehicle service is configured to provide the information that regards various details of the protocols and required information to enable services for the package exchange with a vehicle of a customer over to a server of a retail website. Thus, the module in one of the servers associated with the package-exchange-with-a-vehicle service is configured to provide information regarding the services for a package exchange with a vehicle of a potential customer to the server of the merchant site prior to any purchase of a product. The information regarding services includes one or more package delivery systems with their servers that are set up to cooperate with the servers of the package-exchange-with-a-vehicle service to deliver one or more purchased products from the retail website to an associated target vehicle of the customer. The information regarding the services sent prior to any purchase of a product, is sent from the server of the package-exchange-with-a-vehicle service, via one of the ports, to the server of the merchant site to enable the merchant site to present a button on a user interface 1405 of a shopping application resident on a client device of the customer. The servers supply information regarding services to each of the merchant sites cooperating with the package-exchange-with-a-vehicle service.

The information regarding services which is sent from the server of the package-exchange-with-a-vehicle service to the server of the retail website enables the retail website to present a button on a user interface of a shopping application resident on a client device of the customer. The client device of the customer couples to the retail website for purchasing products from the retail website via its browser or merchant's mobile app. The presented button is configured to enable the customer at a checkout point of the purchase from the retail website, to select an alternative package delivery option of delivering the one or more purchased products to the associated target vehicle of the customer. Thus, the client device couples to the merchant website for purchasing products from the merchant website and interacts with a presented button from the merchant site that is configured to enable the customer at a checkout point of the purchase from the merchant site. The presented button is configured to select an alternative package delivery option of delivering the one or more purchased products to the associated target vehicle of the customer.

A shipping and tracking module in the server associated with the package-exchange-with-a-vehicle service is configured to communicate with the server of the retail website to receive purchase information after the checkout point and completion of the purchase by the customer. The purchase information includes information regarding the customer including their name, and the target vehicle of the customer, at least a package delivery system that is set up to exchange the purchased products with the target vehicle of the customer, and an expected delivery date and delivery location. The purchase information is stored in the one or more databases in the cloud based provider site. The shipping and tracking module is configured to cooperate with at least a database and a processor of the cloud based provider site to process information including a shipping Tracking Number (TN) and a Vehicle Identification Number (VIN) of the target vehicle associated with the purchase and to register the purchase information and a request for package delivery to the target vehicle of the customer in one of the databases of the cloud based provider site associated with the package-exchange-with-a-vehicle service. The shipping and tracking module in the server associated with the package-exchange-with-a-vehicle service is configured to send notices to a package exchange application resident in the client device of the customer. The notices include an expected delivery notice having a date and time of delivery to the target vehicle of the customer, and a confirmation notice of completion of delivery operation to the target vehicle of the customer.

The shipping and tracking module in the server associated with the package-exchange-with-a-vehicle service is configured to communicate with the server of the merchant site to receive purchase information after the checkout point and completion of the purchase by the customer. For example, the package exchange application resident on the first client device of the customer is configured to allow the customer to login to the customer's account of the package-exchange-with-a-vehicle service in order to track the delivery of the purchased products. The module in the server associated with the package-exchange-with-a-vehicle service is configured to receive one or more customer verification requests from the servers of the one or more retail websites. In response to a customer verification request from the retail website, the module is configured 1) to provide a login screen for the customer of the retail website. The shopping application resident on the client device of the customer is redirected from the retail website to the login screen of the cloud based provider site of the package-exchange-with-a-vehicle service to enter customer credentials corresponding to a customer's account of the package-exchange-with-a-vehicle service, or 2) to receive from the server of the retail website, the customer credentials corresponding to the customer's account of the package-exchange-with-a-vehicle service. The customer may be also be verified based on the customer credentials including a username and other credentials.

After the customer verification based on the customer credentials including a username and a password and zero or more security questions, the module provides a response to the server of the retail website. The response includes information regarding the services for package exchange available to the customer and the target vehicle associated with the customer, the package delivery systems that can deliver the purchased products from the retail website to the associated target vehicle of the customer, and a vehicle identification number of the target vehicle of the customer.

A verification response is provided to the server of the retail website, the verification response includes a vehicle identification number of the target vehicle of the customer and information regarding services for package exchange available to the customer and a target vehicle associated with the customer.

Another module in one of the servers in the package-exchange-with-a-vehicle service is configured to use the registered purchase information and to create one or more database records for each completed delivery operation. The module is configured to cooperate with the shipping and tracking module to send a notice to any of i) the server of the retail website, ii) the client device of the customer, and iii) any combination of both, which the notice conveys to the customer associated with the target vehicle confirmation that the package exchange has in fact occurred. The database records of deliveries are stored in the database to keep track of deliveries.

The cloud based package-exchange-with-a-vehicle service uses its one or more servers having one or more processors, one or more ports, in order to cooperate with one or more databases in the system for cloud based package-exchange-with-a-vehicle service as well as databases and servers of the merchant sites.

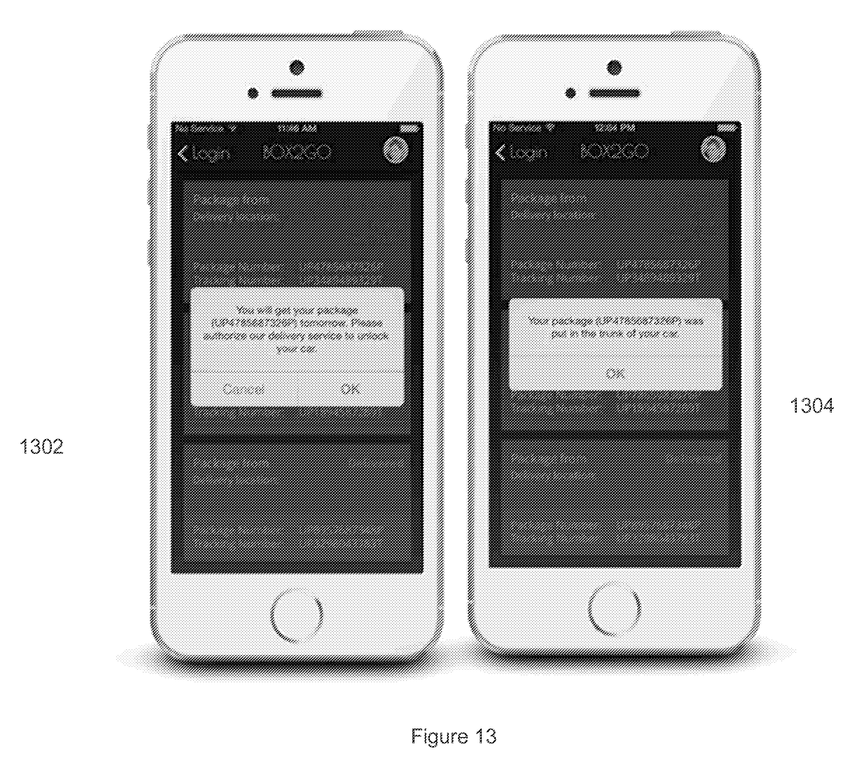

FIG. 13 illustrates diagrams of an application of a package exchange service with a vehicle on a client device used to coordinate a secure package exchange. Note, an example systems and solutions are discussed below. However, similar principles can be applied in any of the solutions discussed herein such as merely using merchant sites and package delivery services without integrating the telematics solution into the design.

On the left hand side, the application (1302) on the client device conveys a notice to the user of a package will be delivered to the target vehicle of the user. This first notice ensures the user actually wants a package delivered to their vehicle and correspondingly confirms they want their vehicle unlocked or otherwise opened for the package exchange. On the right hand side, the application (1304) on the client device conveys a notice to the user that the package delivery to the target vehicle is complete.

A security system used by the cloud-based package-exchange-with-a-vehicle service coordinates a secure package exchange. A security module running on the one or more processors is configured to coordinate the secure package exchange with an access module in a target vehicle by either directly sending an access control sequence and authentication code to a receiver module in a client device or sending an executable software package to be locally calculated by a processor on a client device to generate an appropriate access control sequence and authentication code to access a specific vehicle associated with a user for the package exchange by remotely opening up or unlocking up the target vehicle.

The security module is configured to receive, via one of the ports, a notification of a package exchange request for the user either i) from a server of a package delivery system or ii) from a server of a merchant site, and where the security module is configured via a first port to receive credentials of the user corresponding to an account of the user stored in a database of the package-exchange-with-a-vehicle service and configured to verify the user based on the credentials of the user including a username, a password, and one or more security questions. After the verification, the security module is configured to send, via one of the ports, a verification response i) to the server of the package delivery system, ii) to the server of the merchant site, or iii) both. After the verification, the security module is configured to look up in the database in the cloud-based package-exchange-with-a-vehicle service for one or more contact information listings for the user. A first routine then is coded to create one or more notifications, including any of e-mail notifications, SMS text notifications, and mobile app notifications, to one or more client devices associated with the user; where the one or more notifications request the user to take action to verify that a package exchange with their target vehicle has indeed been requested by that user.

A second routine in the security module is configured to, when there is more than one vehicle associated with the account of the user, via one of the ports, to receive confirmation of which one of the vehicles associated with the account of the user will be the target vehicle used for the package exchange with the package delivery system, the received confirmation is from any of the following i) the client device of the user, ii) the server of the merchant site, and iii) the server of the package delivery system.

The security module in the server, before sending commands to the target vehicle of the customer, the security module in the server associated with the package-exchange-with-a-vehicle service receives at least two virtual verification keys. A first virtual verification key from a second client device associated with a package delivery vehicle and a second virtual verification key from the client device of the customer. The second virtual verification key from the client device of the customer is based on or generated when the response of the user to the first notice that ensures the user actually wants a package delivered to their vehicle.

The security module, in a server associated with the package-exchange-with-a-vehicle service, is configured to setup a package delivery operation including 1) a first routine to direct delivery of the one or more purchased products to the associated target vehicle of the customer, 2) a second routine to open and/or unlock the target vehicle of the customer to ensure the one or more purchased products can be delivered, 3) a third routine to ensure the one or more purchased products have been delivered, and 4) a forth routine to ensure, after delivery of the purchased products, the target vehicle of the customer is closed and locked. A package-exchange-with-a-vehicle service is configured to cooperate with an onboard actuation module installed in a target vehicle in a number of different ways. The onboard actuation module may be any of i) an onboard telematics module installed in the target vehicle of the customer and configured to communicate with a cloud based server associated with the package-exchange-with-a-vehicle service through a cloud based telematics provider, ii) a key fob access module installed in the target vehicle, or iii) a dongle module having a Wi-Fi or cellular communication circuit configured to establish a secure communication with the cloud based server associated with the package-exchange-with-a-vehicle service. The dongle is also coupled to an electro-mechanical activation circuit configured to cooperate with a fault and diagnostic module installed in the target vehicle of the customer to retrieve diagnostic data including the GPS coordinates of the target vehicle of the customer.

An embodiment of a key fob access module may be a Body Control Module (BCM) installed in the target vehicle. A first rolling security key can be used by of a Body Control Module (BCM) of the target vehicle of the customer. The security module in the server associated with the package-exchange-with-a-vehicle service is configured to command the onboard actuation module in the target vehicle of the customer via using Wi-Fi or cellular communication to establish a secure communication with the onboard actuation module and to send commands including the lock and unlock commands using one or more rolling security keys of a Body Control Module of the target vehicle of the customer to the onboard actuation module. The onboard actuation module may include a Radio Frequency circuitry of a key fob entry system. After receiving the sequence of commands and the rolling security keys, the onboard actuation module communicates RF signals including the corresponding commands and rolling security keys to the Body Control Module of the target vehicle of the customer to perform mechanical operations including locking and unlocking of the target vehicle.

The security module in the server associated with the package-exchange-with-a-vehicle service may be configured to send commands including the lock and unlock commands and one or more rolling security keys of a Body Control Module of the target vehicle of the customer to a second client device associated with a package delivery vehicle. The hand held client device allows the delivery person to use the key fob simulator in the client device to transmit RF signals including commands and rolling security keys to the RF circuitry and/or Body Control Module of the target vehicle of the customer to perform mechanical operations including locking and unlocking of the target vehicle.

The first virtual verification key is given a first shelf life and the second virtual verification key is given a second shelf life such that sending of the commands stay within an overlap window of time between the first shelf life and the second shelf life.

The first virtual key may be a public key selected from a pool of virtual keys in the database associated with the package-exchange-with-a-vehicle service and provided through the package delivery system to the second client device of the package delivery vehicle. The pool of virtual keys including one or more public keys and associated private keys, where the received first virtual key is used by the security module of the server associated with the package-exchange-with-a-vehicle service to authenticate communications received from the package delivery vehicle.

The first virtual key is received from the client device of the customer, the first virtual key is either 1) a token supplied by a telematics provider to the client device of the customer and then by the client device of the customer to the security module. The security module is configured to send the security token and one or more commands to the telematics provider, where the security token is used by a verification module of the telematics provider to verify the customer and the target vehicle of the customer before sending the command to an onboard telematics module of the target vehicle, or 2) a first rolling security key of a Body Control Module (BCM) of the target vehicle of the customer. The first rolling security key is used by the security module of the server associated with the package-exchange-with-a-vehicle service to generate a next second rolling security key for the BCM of the target vehicle of the customer to be used by a delivery person of the package delivery vehicle via a universal key fob simulator for sending the commands including lock and unlock commands to the BCM of the target vehicle of the customer.

A GPS-based proximity module in the security module associated with the package-exchange service may be configured to receive both current GPS coordinates of a package delivery vehicle and current GPS coordinates of the target vehicle of the customer. The set of current GPS coordinates allow at least one of i) package delivery to the target vehicle of the customer and ii) package pick up from the target vehicle of the customer. The GPS-based proximity module is further configured to monitor a distance between the package delivery vehicle and the target vehicle of the customer and in cooperation with the security module to send to an onboard actuation module in the target vehicle of the customer one or more commands 1) to wake-up the onboard actuation module in the target vehicle of the customer while in a close proximity established by a first threshold distance between the package delivery vehicle and the target vehicle of the customer, 2) to give an alert from the target vehicle of the customer while in a close proximity established by a second threshold distance between the package delivery vehicle and the target vehicle of the customer, 3) to unlock a door including a trunk of the target vehicle of the customer, and 4) established by a fourth threshold distance to lock the doors of the target vehicle of the customer after receiving a confirmation of the package delivery operation from a second client device associated with the package delivery vehicle. The GPS-based proximity module of the security module may be configured to receive the current GPS coordinates of the package delivery vehicle from the second client device in the package delivery vehicle and the current GPS coordinates of the target vehicle of the customer from one of 1) the onboard actuation module installed in the target vehicle of the customer, or 2) the client device of the customer. Thus, the GPS-based proximity module of the server associated with the package-exchange-with-a-vehicle service is configured to receive the current GPS coordinates of the target vehicle of the customer from an onboard module of the target vehicle or from an application resident in a smart phone of the customer.

The security module in the server associated with the package-exchange-with-a-vehicle service may be configured to communicate with a client device of the package delivery service to the onboard key fob access module of the target vehicle of the customer, the package delivery operation includes sending commands for 1) giving an alert by the target vehicle of the customer, 2) opening the target vehicle of the customer and 3) ensuring the target vehicle of the customer is closed and locked after delivery.

### High Level Description of Each Transaction in Case of Telematics Solution

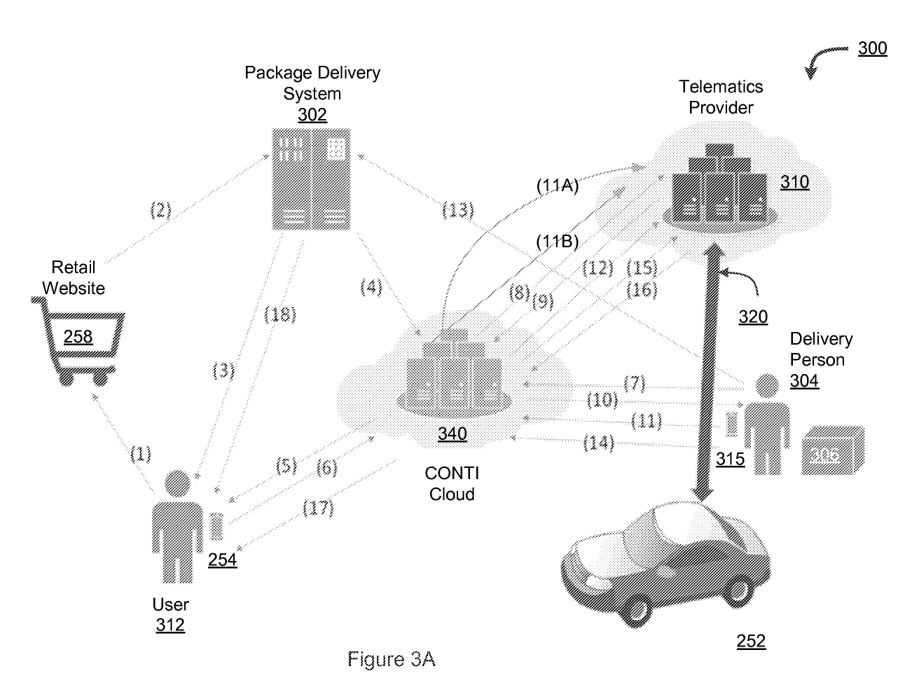

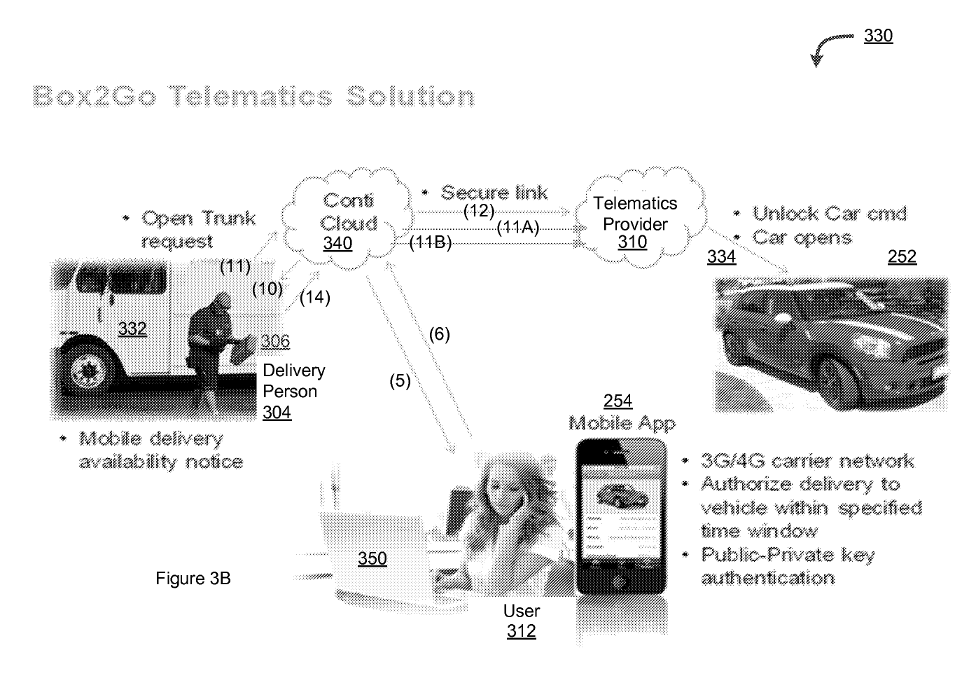

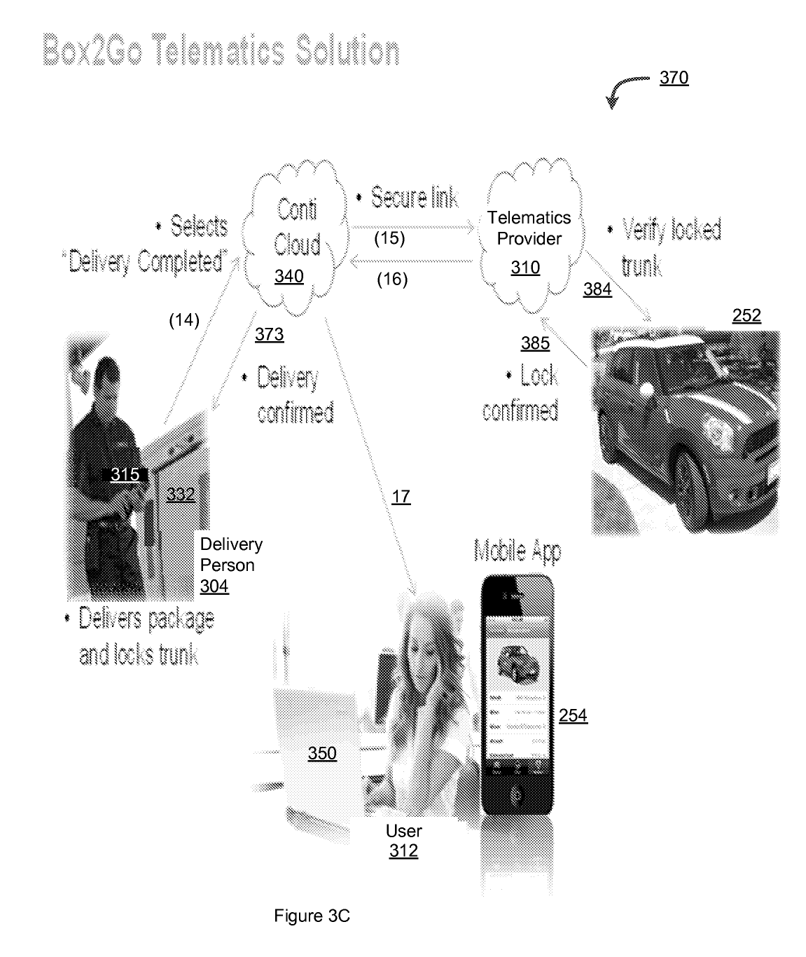

FIGS. 3A-3C illustrate block and flow diagrams of embodiments of the alternative delivery system using a telematics solution. Note, an example telematics solution is discussed below. However, similar principles can be applied in solutions merely using merchant sites and package delivery services without integrating the telematics solution into the design.

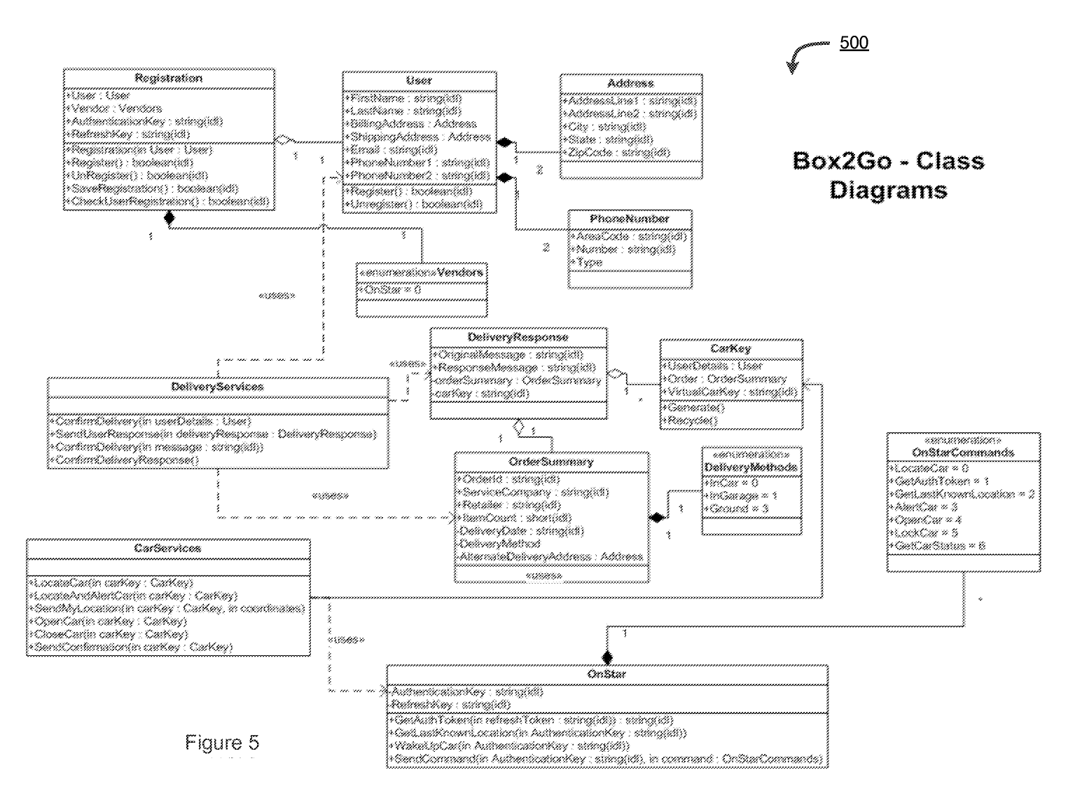

The alternative package pickup and delivery system is discussed. The system includes a cloud-based package-exchange-with-a-vehicle service that is hosted on a cloud-based provider site, one or more package delivery entity systems, such as FedEx, having both a service website as well as one or more delivery vehicles with client devices having a first delivery application resident in each client device, and one or more OEM ‘remote access/connectivity’ systems that are configured to have communications between the cloud and a vehicle in order to exchange information including GPS coordinates of the vehicle and interact with the vehicle's on-board intelligence system, such as an on-board telematics module, to cause electromechanical actions within that vehicle including: unlocking doors, opening windows, opening trunks, closing trunks, opening and closing a sunroof or moon roof. Thus, the on-board intelligence system may cause the opening & closing of those mechanical portions of the car/vehicle. The cloud-based package-exchange-with-a-vehicle service is hosted on a cloud-based provider site that contains one or more servers and one or more databases. The cloud-based package-exchange-with-a-vehicle service is coded to utilize a protocol, including HTTP, to engage in a request and response cycle with either i) a mobile device application resident on a client device, ii) a web-browser application resident on the client device, or iii) both. The cloud-based package-exchange-with-a-vehicle service has one or more routines to automate the package to and from vehicle delivery. The cloud-based package-exchange-with-a-vehicle service has one or more open application programming interfaces to standardly exchange information between the two or more package delivery sites and/or the two or more OEM ‘remote access/connectivity’ systems such as an OEM telematics system. (See FIG. 5 for an example class diagram of an embodiment of an application programming interface for the alternative package pickup and delivery system.) The telematics systems are configured to have wireless communications between a server in the cloud and a given vehicle. A hardware module, such as a telematics module, in the vehicle then causes electromechanical actions within that given vehicle in order to allow the cloud-based package-exchange-with-a-vehicle service to access a plurality of different kinds of vehicles, manufactured from a number of different manufactures. An example telematics module may cooperate with or be part of a navigation system in the vehicle. The cloud-based package-exchange-with-a-vehicle service has a communication module scripted to establish a communication link with a communication terminal of either or both of the telematics systems or the package delivery sites via a communication network. The cloud-based package-exchange-with-a-vehicle service has an additional communication module scripted to exchange information with a delivery application on a client device in order to send or receive information from a delivery person. The cloud-based package-exchange-with-a-vehicle service has an additional communication module for a user of the target vehicle having a package picked up or delivered to that vehicle, which is scripted to exchange information with a mobile application or desktop application on a client device. The package may be a retail shop item, flowers, perishables, tobacco and alcohol, postal letters, food or other consumable items, and other similar deliverable items. The vehicles include but are not limited to automobiles, trucks, vans, motorcycles, and other similar transportation mechanisms. The OEM ‘remote access/connectivity’ systems can include manufacturers, such as Tesla Motors, who have backend servers that directly communicate with a telematics module in the vehicle.

FIG. 3A illustrates an example sequence of steps.

(1) The User uses either a mobile application on their client device or accesses a retailer's website via a browser on their client device. The retailer's website collects order information including the products selected. The client device submits order and shipping information via the mobile application to the retailer's website, in the case of delivering to a vehicle, the shipping information includes the vehicle VIN. The user interface of the retailer's website offers the alternative delivery destination of the consumer's/user's vehicle as a delivery destination. Note, the retailer's website user interface may show the alternative delivery destination of the consumer's/user's vehicle and an additional monetary charge may be associated with this alternative delivery destination. The additional monetary charge may be charged on a per delivery instance basis or based on a subscription basis.

(2) The retailer's website sends shipping information to the package-delivery-entity-system, such as FedEx.

(3) The package-delivery-entity-system sends confirmation including Tracking Number to the User on their client device.

(4) The package-delivery-entity-system sends a notification to the package-to-and-from-the-vehicle-service cloud system, including Tracking Number and VIN via the standardized open application programming interface. The notification including the shipping Tracking Number and VIN are stored in the databases of the package-to-and-from-the-vehicle-service cloud system.

(5) The package-to-and-from-the-vehicle-service cloud system sends a notification to either the mobile application or the desktop application on their client device and confirms with the User their desire to have a package shipped to their vehicle with the Tracking Number and VIN for the package delivery. The confirmation notice also acts as a security mechanism to ensure that the user did in fact elect to have a package delivered to their vehicle.

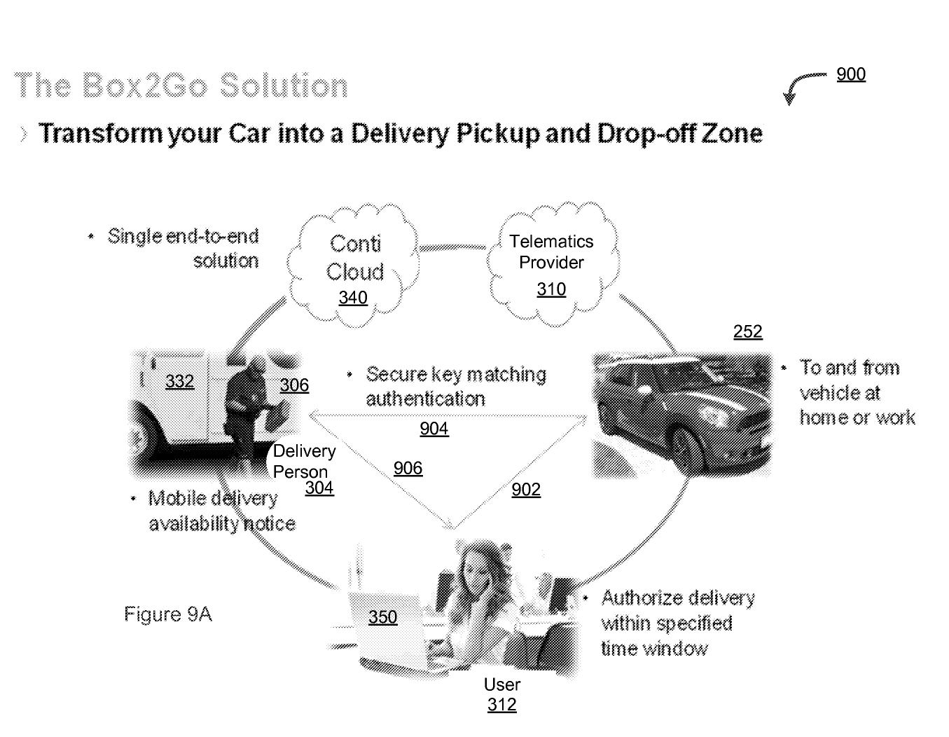

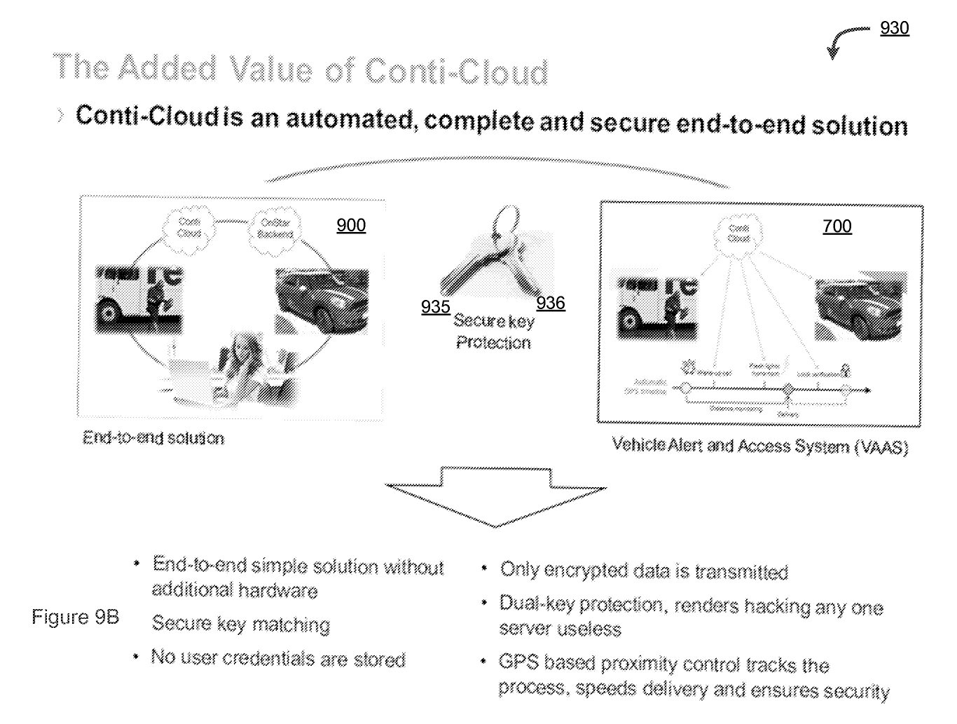

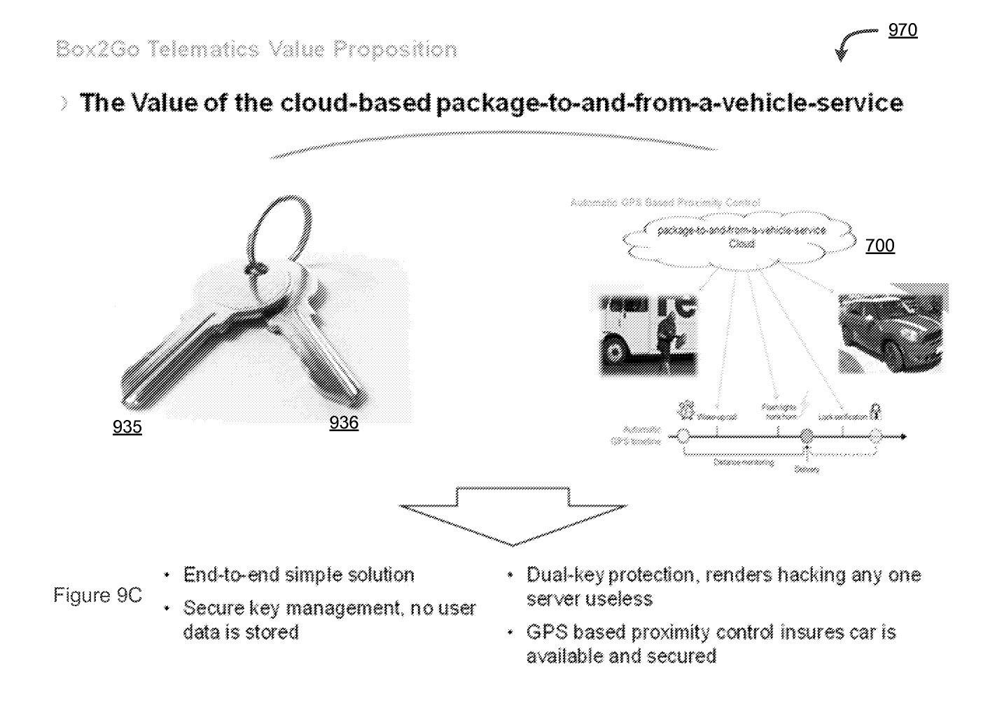

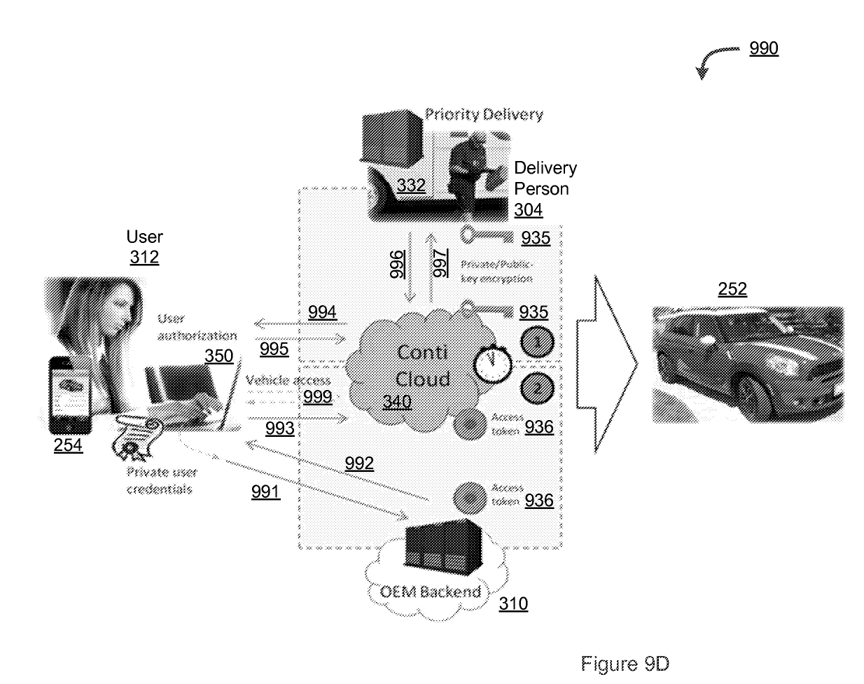

(6) The User supplies a response into either the mobile application or the desktop application on their client device to send permission (User name and Password) for the telematics system, such as OnStar, to the package-to-and-from-the-vehicle-service cloud system. The package-to-and-from-the-vehicle-service cloud system has a multiple step, such as a two-phase, verification mechanism. The cloud-based infrastructure is scripted to validate authorization for the package delivery service to a registered owner's vehicle. The source of initiating the request to open up the car is verified twice as a delivery order key coming from a package delivery entity and is verified to match the initial request coming from the package-to-and-from-the-vehicle-service as well as the car actuation virtual key coming from the telematics system, which both are verified to match the initial request coming from the-package-to-and-from-the-vehicle-service in the cloud. (See FIGS. 9A-9D on block diagrams of embodiments of the multiple paired virtual keys and security authorization notices used by the package-exchange-with-a-vehicle service.)

The details from the package delivery entity system associated with the delivery key have to match the details of the initial request submitted by the package-to-and-from-the-vehicle-service and are then sent over to the package delivery entity system. Likewise, the details associated with the car actuation key from the from telematics entity system have to match the details of the initial request submitted by the package-to-and-from-the-vehicle-service cloud and are then sent over to the telematics entity system. The package-to-and-from the-vehicle-service stores these details in a database, tracks the expected delivery vehicle and knows the location of the target vehicle, and after determining its proximity is close, then the virtual key will allow for the opening of the vehicle.

(7) After the package arrives at the same city, the package delivery entity system's delivery person uses the package delivery application in their client device to send the Tracking Number to the package-to-and-from-the-vehicle-service the-vehicle-service in order to obtain the vehicle's information including its current location information.

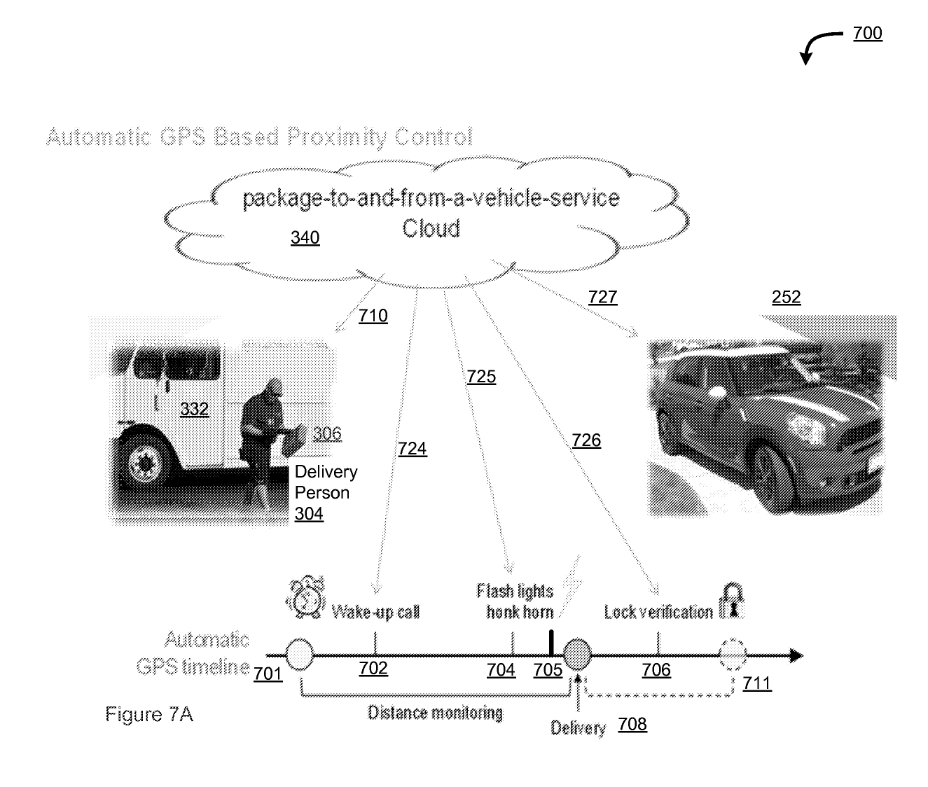

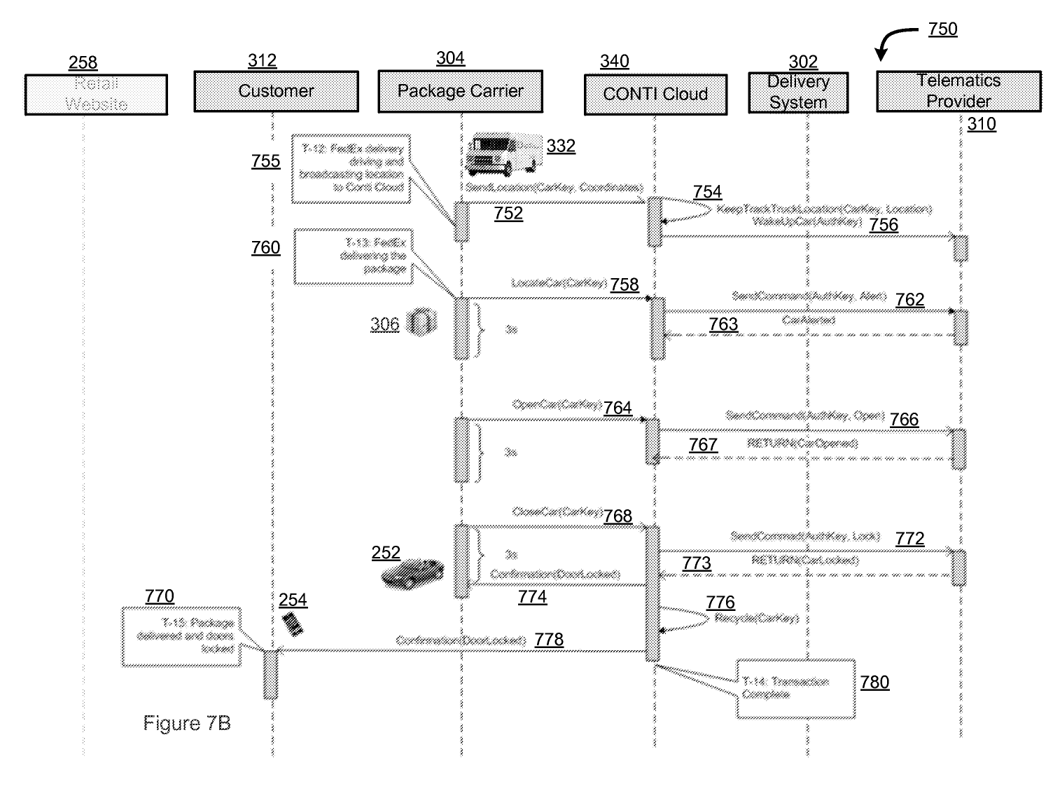

(8) The package-to-and-from-the-vehicle-service the-vehicle-service in the cloud sends a request via the one or more open application programming interfaces to the OEM backend of the telematics entity system for the vehicle's current GPS location information using its VIN. (See FIGS. 7A and 7B on embodiments of the GPS-based control and tracking mechanisms used for delivery to or pick-up from the vehicle.)

(9) The telematics system OEM backend site communicates with the vehicle's navigation system and sends back the vehicle location information from the vehicle's navigation system via the one or more open application programming interfaces to the package-to-and-from-the-vehicle-service cloud system. The package-to-and-from-the-vehicle-service cloud system stores this information in its database.

(10) The package-to-and-from-the-vehicle-service cloud system responds to the package delivery application in the client device of the delivery person with the vehicle's location information.

(11) Upon approaching vehicle, the package delivery application in the client device of the delivery person either independently detects a distance between the package delivery vehicle and the target vehicle or can also be prompted by the delivery person to send a request to the package-to-and-from-the-vehicle-service cloud system to wake up the vehicle. The vehicle's telematics module may be in a sleep-mode as this prevents battery drain when vehicle is not in use and thus the vehicle's telematics module needs to be sent a wake up notice. The package-to-and-from-the-vehicle-service cloud system via the one or more application programming interfaces sends one or more wake up requests to the telematics system OEM Backend in order for the telematics system OEM Backend to wake up the vehicle.

Vehicle Alert and Access System (VAAS) via a GPS-based proximity control:

Additionally, the distance between the delivery vehicle with the delivery application resident in its client device feeding the GPS of the coordinates of the delivery vehicle and the target vehicle's GPS coordinates as periodically fed back by the telematics system OEM Backend is monitored and compared by a GPS based proximity control routine in the package-to-and-from-the-vehicle-service cloud system.

1) The GPS based proximity control routine in the package-to-and-from-the-vehicle-service cloud system via the one or more application programming interfaces sends one or more wake up requests to the telematics system OEM Backend to wake up the target vehicle as the FedEx truck arrives near the target vehicle. However, without the advanced sequence of wake up requests, the vehicle telematics control may be in sleep mode and a delivery driver might be forced to wait 10 minutes or more to unlock the door. This wake up control insures an Unlock Vehicle command will execute immediately when FedEx arrives since the vehicle is awake. In order to prevent a delay due to in-vehicle power saving mode, the vehicle's telematics module is sent a command to execute the command to unlock the door immediately. This improves productivity since the vehicle can be opened immediately when FedEx arrives, since the vehicle is awake and ready to accept commands. Note, in an embodiment, for security, package-to-and-from-the-vehicle-service cloud system will grant access to the vehicle only once. Subsequent requests will not open the vehicle even if correct virtual key and valid time window are present.

2) A GPS-based proximity control routine in the package-to-and-from-the-vehicle-service cloud system will also send a request via the one or more application programming interfaces to the telematics system OEM Backend to send a command to cause a localized alert in the target vehicle so that the vehicle can blink the vehicle's lights and honk its horn to alert the delivery driver directly to the target vehicle's location, in order to save time and aid in locating the target vehicle within rows of parked cars. Alternatively, the package-to-and-from-the-vehicle-service cloud system itself can be scripted to send a command directly to the vehicle's telematics module to blink lights and honk its horn to alert delivery driver directly to vehicle's location. This ensures the designated target vehicle is identified properly and increases efficiency of delivering or picking up of the package.

(12) Optionally, the GPS based proximity control routine waits for a confirmation from the delivery application that the vehicles driver has located the target vehicle. The GPS based proximity control routine composes a correct request command and sends the request via the one or more application programming interfaces to the telematics system OEM Backend to send a command to the intelligent vehicle's telematics module in the vehicle to open the trunk of the vehicle or some other electro-mechanical actuation of a window, sunroof, or other opening to a secure compartment of the target vehicle for placement of the package.

(13) Upon opening trunk, the package delivery person picks up or stores the package into the vehicle, and closes the trunk.

(14) The package delivery entity system's delivery person sends confirmation of the package delivery/pickup and the securing of the target vehicle via the delivery application on the client's device to the package-to-and-from-the-vehicle-service cloud system. Alternatively, the delivery application on the client's device can be configured to monitor for the confirmation sent by the package delivery person to the package delivery system.

(15) After a confirmed delivery of the package from the delivery application in the delivery person's client device, the GPS-based proximity control routine in the package-to-and-from-the-vehicle-service cloud system can receive GPS coordinates from the delivery application in the delivery person's client device. The GPS based proximity control routine performs distance monitoring to recognize when the delivery driver is departing and then is scripted to verify that the target vehicle is locked, in order to avoid the delivery person leaving an unlocked vehicle. The package-to-and-from-the-vehicle-service in the cloud system checks the trunk's status by sending the request to the telematics system's OEM backend.

(16) The GPS based proximity control routine in the package-to-and-from-the-vehicle-service cloud system sends a request via the one or more application programming interfaces to the telematics system OEM Backend to send a command to the intelligent telematics module in the vehicle to confirm the vehicle's trunk is both closed and locked. The telematics system's OEM backend also sends back a confirmation or not that the vehicle's trunk is both closed and locked. If not, the GPS-based proximity control routine in the package-to-and-from-the-vehicle-service cloud system sends a request via the one or more application programming interfaces to the telematics system OEM backend to send a command to the intelligent vehicle's telematics module in the vehicle to close and lock the vehicle's trunk. This feature improves security to insure the vehicle is locked after departure.

Note, the GPS proximity application is scripted to perform multiple actions including i) waking up a vehicle via its associated telematics system ii) facilitating for the electro mechanical operations in the vehicle to occur, such as unlocking/locking doors, opening/closing windows, opening and unlocking/closing and locking a trunk, opening/closing sunroof, and iii) detecting when the delivery or pick up of the package in vehicle is at a certain distance away from the target vehicle, then the vehicle should be secure at that point.

(17) The package-to-and-from-the-vehicle-service cloud system sends delivery confirmation to the User on either the mobile application or the desktop application on their client device.

(18) The package delivery entity system sends delivery notice email to the User.

### High Level Description of Each Transaction in Case of Dongle/eHorizon Solution

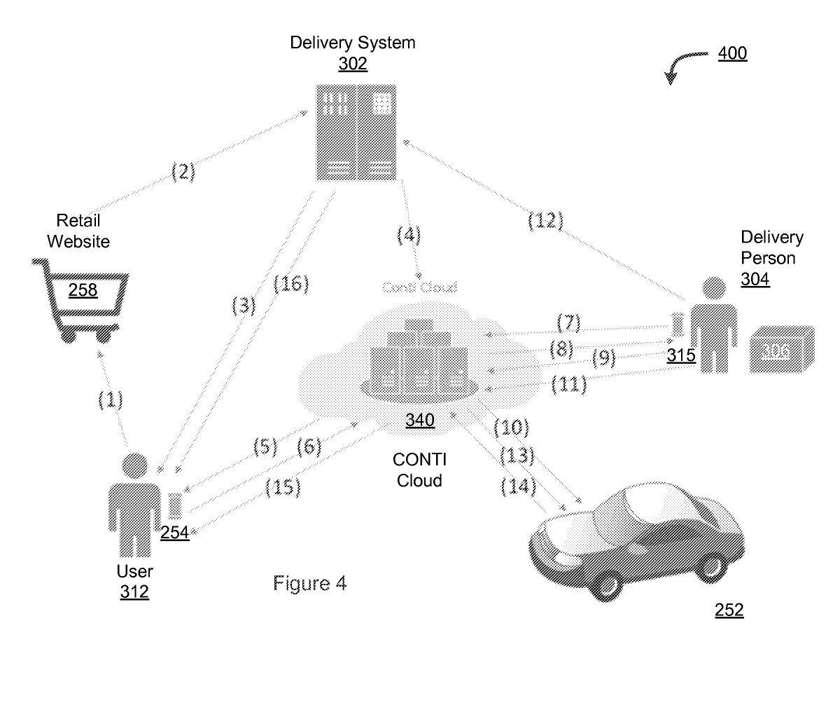

FIG. 4 illustrates a flow diagram of an embodiment of the alternative package pickup and delivery system using an example Dongle/eHorizon topology.

In an embodiment, a software application, such as eHorizon, is configured to provide a new intelligence in a vehicle's navigation. eHorizon software leads the way to an intelligent and expanded use of navigation data to control other vehicle systems. Additional hardware may be installed in the target vehicle to assist in the package to and from the vehicle process. A dongle may be a small piece of hardware that attaches to the vehicle in order to enable additional functions.

(0) Steps 1-7 are the same as the previous solution.

(1) The User uses either a mobile application on their client device or accesses a retailer's website via a browser on their client device. The retailer's website collects order information including the products selected. The client device submits order and shipping information via the mobile application to the retailer's website, and in the case of delivering to a vehicle, the order includes the vehicle VIN.

(2) The retailer's website sends shipping information to the package delivery entity system.

(3) The package delivery entity system sends confirmation including a Tracking Number to User.

(4) The package delivery entity system sends notification to the package-to-and-from-the-vehicle-service cloud system, including the Tracking Number and VIN.

(5) The package-to-and-from-the-vehicle-service cloud system confirms with the User via Tracking Number and VIN.

(6) User sends Permission (User name and Password) for the telematics system to the package-to-and-from-the-vehicle-service cloud system.

(7) After the package arrives in the same city, the package delivery entity system's delivery person sends the Tracking Number to the package-to-and-from-the-vehicle-service cloud system for vehicle location information.

(8) After step (6), the package-to-and-from-the-vehicle-service cloud system has tracked the vehicle's location and sends it out upon a request from the package delivery person.

(9) After the package delivery entity system's delivery person approaches the vehicle, a request is sent to the package-to-and-from-the-vehicle-service cloud system to blink the hazard lights and open the trunk.

(10) The package-to-and-from-the-vehicle-service cloud system verifies the request and unlocks the trunk.

(11) After storing the package into the trunk and closing the trunk, the package delivery entity system's delivery person sends a confirmation to the package-to-and-from-the-vehicle-service cloud system.

(12) The package delivery entity system's delivery person sends confirmation to the package delivery entity system.

(13) After (11), the package-to-and-from-the-vehicle-service cloud system polls the trunk door status of the vehicle.

(14) Dongle/eHorizon responds with the trunk door status (open/closed).

(15) The package-to-and-from-the-vehicle-service cloud system sends a delivery confirmation notice to the User.

(16) The package delivery entity system sends delivery confirmation email to User.

The Dongle/eHorizon solution utilizes the OEM to access BCM. Most of the transactions are protected by HTTPS protocol (public-private key pairs and certificate). A security mechanism such as HTTPS protocol is supported by all popular web frameworks. The whole system has several cyber security mechanisms: i) the server in the package-to-and-from-the-vehicle-service cloud system needs to apply for a certificate from one of the trusted CAs, ii) the package delivery entity system's delivery person needs to register for verification, and iii) the User needs to register with the package-to-and-from-the-vehicle-service cloud system to use the service by both verifying the vehicle type is supported and identifying the verification with OEM backend.

### High Level Description of the Package-to-and-from-the-Vehicle-Service Processes

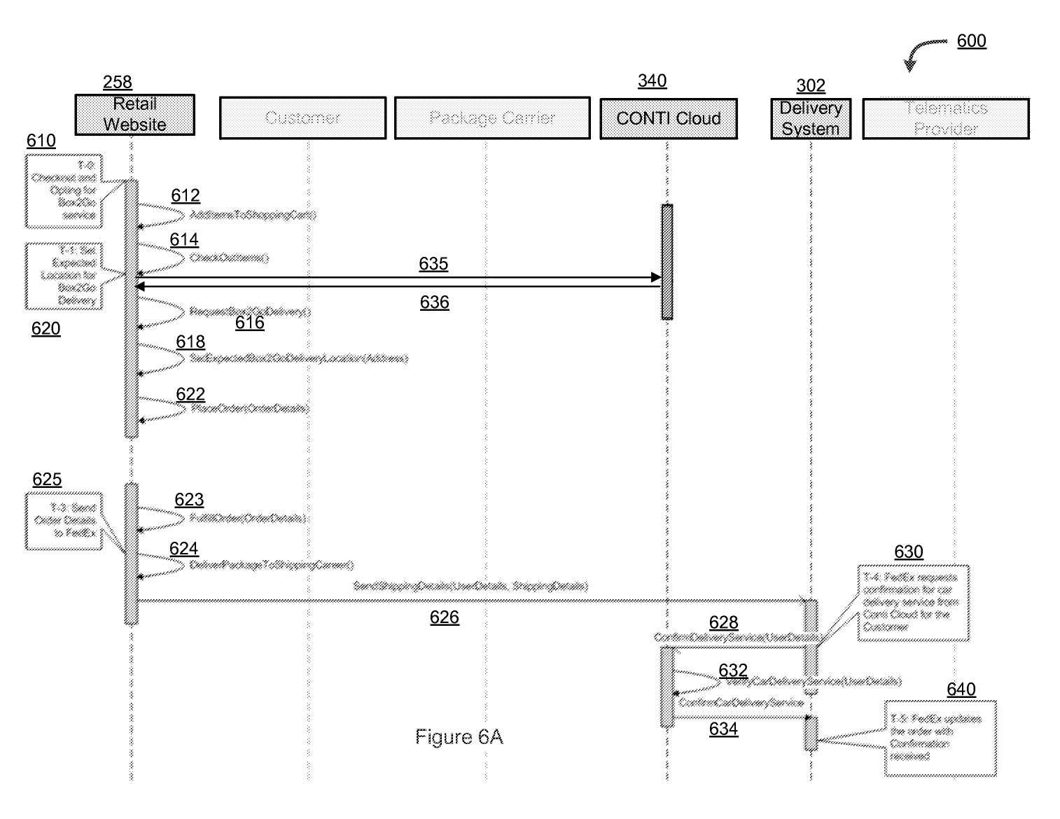

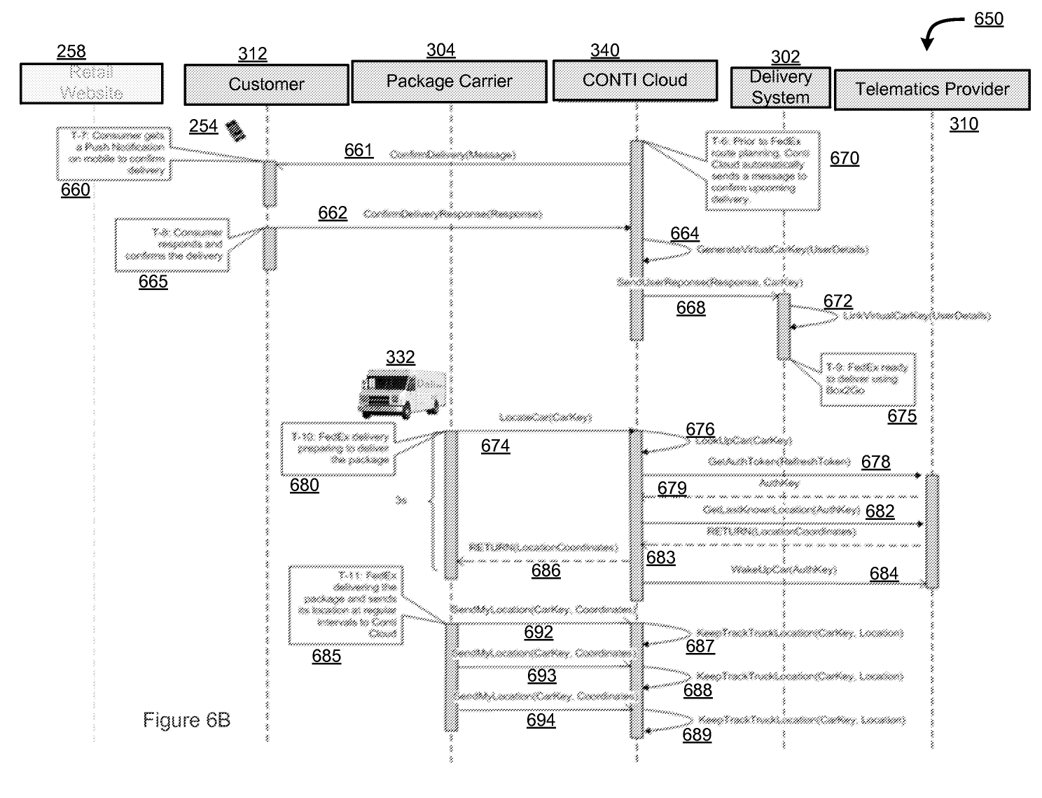

FIGS. 6A-6B illustrate flow diagrams of embodiment of the alternative delivery system.

i) Registration and purchase: There are multiple time periods and methods a customer can select to register with the package-to-and-from-the-vehicle-service. Upon registering, a first database in the one or more databases may be also configured to contain and index information regarding for each user including: User ID and password for the package-to-and-from-the-vehicle-service, User name, email, etc., security questions, vehicle VIN, vehicle model, color and year, and other similar information.

1) When purchasing a new car at the dealership with a telematics system built into the vehicle the following steps are performed: i) the customer is offered to sign-up for the package-to-and-from-the-vehicle-service, ii) the customer signs up for the Box2Go service application in the cloud-based package-exchange-with-a-vehicle service using a paper form and the customer downloads the Box2Go mobile app into their client device, iii) the customer logs-in to the Box2Go mobile app at least once to activate the Box2Go service application in the cloud-based package-exchange-with-a-vehicle service. Next, the cloud-based package-exchange-with-a-vehicle service automatically tracks the Authentication Key and Refresh Key for the user and stores it as part of the registration.

2) A customer may register using the Box2Go Application by i) using the Box2Go app to sign up, ii) Box2Go collects the registration information for the telematics system site (e.g. OnStar's Backend site) from the user and passes it to the telematics system site, (Box2Go mobile application or the cloud-based package-exchange-with-a-vehicle service does not store this information in the cloud system), iii) the telematics system site finishes the registration and returns the Authentication Key and Refresh Key, and lastly iv) the cloud-based package-exchange-with-a-vehicle service stores the Authentication Key and Refresh Key as part of the registration.

3) When an already existing User registers, the Box2Go app collects the username and password from the telematics system site customer, Box2Go signs up the customer, and the telematics system site returns the Authentication Key and Refresh Key. The cloud-based package-exchange-with-a-vehicle service stores the Authentication Key and Refresh Key as part of the registration.

4) The shopping experience may be as follows. While shopping at a retail store, at checkout, the customer will i) purchase a product on a retail website e.g. Amazon, BestBuy, eBay, etc., ii) be offered an option on the user interface to have the purchased items delivered to his car using the Box2Go service application in the cloud-based package-exchange-with-a-vehicle service, iii) selects the delivery method as “Box2Go Delivery,” to have the package delivered to the vehicle, iv) optionally, selects the expected location of the vehicle to be either work or home, and v) checks-out and places the order with the retailer. The retailer will fulfill the order and prepare the package for delivery and delivers the package with a delivery service provider like FedEx. For example, see FIG. 14 for an example merchant site presenting a button on a user interface of a shopping application resident on a first client device of the customer.

ii) The delivery service provider's Box2Go Delivery Process for use cases including communications via Wi-Fi hotspots, the telematics solution, and blue tooth exchanges between the internal intelligent software in the vehicle itself and the downloaded application resident on the client device.

1) For packages marked for “Box2Go Delivery”, the delivery service provider initiates a query process for the delivery of the package with the package-exchange-with-a-vehicle service in the cloud. The package-exchange-with-a-vehicle service cloud verifies the customer information who requested the package delivery in its system and confirms that the customer has the Box2Go service application in the cloud-based package-exchange-with-a-vehicle service available to allow for such a delivery. The package-exchange-with-a-vehicle service cloud then sends verification back to the delivery service provider's site that the customer can accept a Box2Go delivery.

iii) Shipping Experience

### Delivery Planning

1) Prior to the delivery service provider's route planning, the cloud-based package-exchange-with-a-vehicle service sends a push message (preferably early in the morning) to the customer's cell phone of the Customer requesting confirmation for the vehicle delivery for the package with the Order details. The Customer confirms the vehicle delivery option by sending a message back to the cloud-based package-exchange-with-a-vehicle service. The customer may notice a push-message for Box2Go application. Once the cloud-based package-exchange-with-a-vehicle service receives the customer's confirmation for the car delivery, the cloud-based package-exchange-with-a-vehicle service will generate a virtual Car Key. The cloud-based package-exchange-with-a-vehicle service sends a virtual Car Key to the delivery service provider server. The virtual Car Key is issued with a limited shelf life and will expire even if not used within a defined amount of time, such as 4 hours. Note, the dual key security protects against if either the virtual Car key or access token are compromised. The limited shelf life expiration protects against if BOTH the virtual Car Key and access token are compromised, they are only valid for a limited window of time established by the cloud-based package-exchange-with-a-vehicle service. Thus, the security of the vehicle is protected in multiple ways. The delivery service provider system then links the virtual Car Key to the delivery order. The delivery service provider systems are then ready to execute the package delivery to the Customer's vehicle.

### Pre-Delivery

2) The delivery service provider prepares the Box2Go package to be delivered to the customer's car. The delivery service provider plans the delivery route based on either the address selected for Box2Go delivery at the time of check-out or the current location of the vehicle. On delivery day, the delivery service provider's delivery vehicle looks up the virtual Car Key associated with the order in the Box2Go app. The delivery service provider contacts the cloud-based package-exchange-with-a-vehicle service to get the location of the car. The cloud-based package-exchange-with-a-vehicle service then receives the last known location of the car and sends it back to the delivery service provider's Box2Go app. If the current location of the vehicle is in his delivery zone, the delivery service provider's system moves ahead with the delivery. If the vehicle to deliver to is not in the delivery zone, then that delivery is skipped and marked for differed mail delivery.

### Real-Time Tracking of the Delivery Service Provider's Vehicle

3) While tracking the delivery service provider's delivery vehicle driving toward the delivery location, an application in the delivery vehicle can notify the cloud-based package-exchange-with-a-vehicle service of the delivery vehicle's location. The cloud-based package-exchange-with-a-vehicle service anticipates the delivery of a package to the car and wakes up the vehicle's system by issuing a command. When the delivery service provider's vehicle approaches near the car (like 100 meters), the cloud-based package-exchange-with-a-vehicle service automatically alerts the vehicle and the vehicle starts flashing lights and beeps a few times. This helps the delivery service provider's driver to locate the exact vehicle in a parking lot.

4) To unlock the car once delivery service provider's delivery reaches the car, the application used by the delivery person uses the Box2Go app to send an Unlock command. The cloud-based package-exchange-with-a-vehicle service intercepts this command and issues an Unlock command to the telematics system site. The telematics system site triggers an unlock request in the car's telematics module by sending this Unlock command to electromechanically unlock a trunk or door of the vehicle.

5) The delivery person places the package inside the customer's car, closes the car door/trunk, and then uses the Box2Go app to send a lock command. Like above, the cloud-based package-exchange-with-a-vehicle service intercepts this command and issues a Lock command to the telematics system site. The telematics system site triggers a lock request in the car's telematics module by sending the lock command.

6) A confirmation message is sent from the package-exchange-with-a-vehicle service to the delivery service provider's server and to the customer on the Box2Go app on the customer's cell phone. The delivery process is completed when the package-exchange-with-a-vehicle service destroys the virtual CarKey for the order.

### Revenue

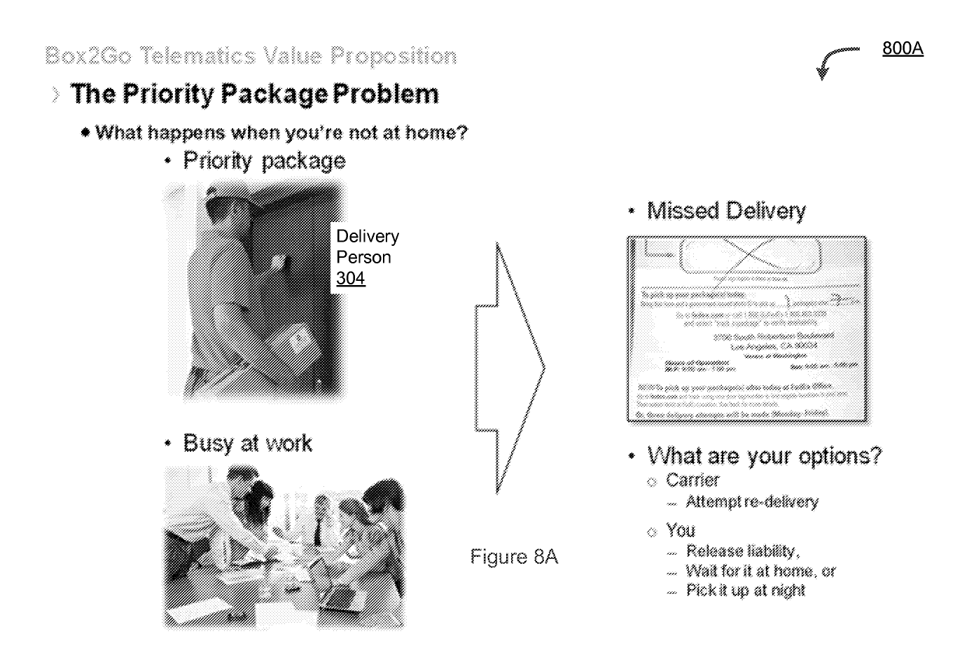

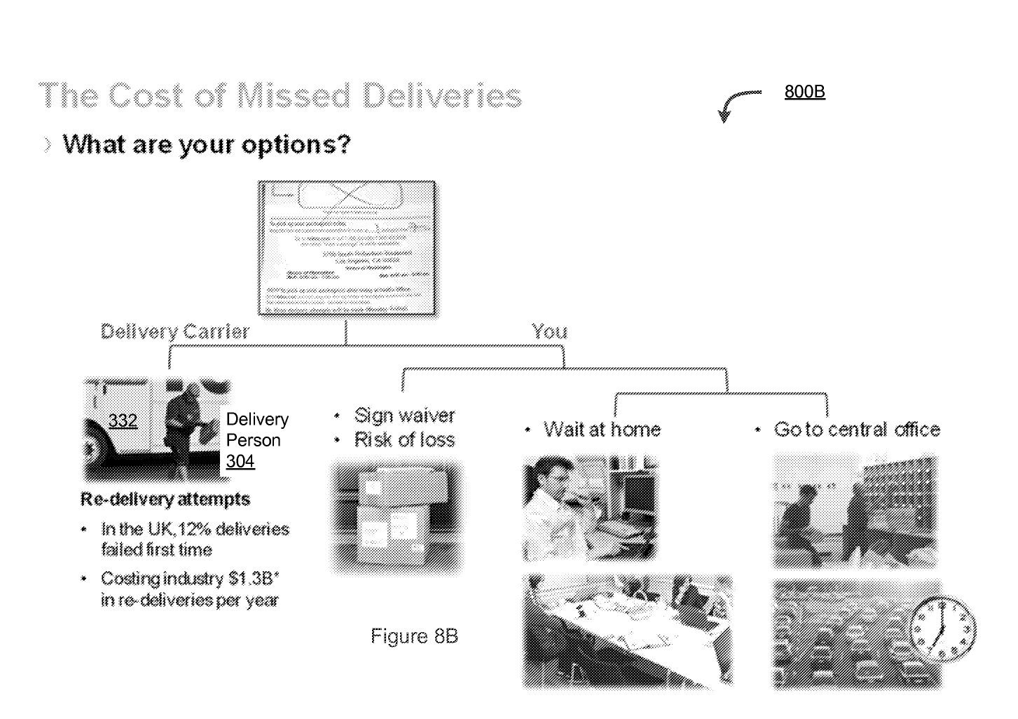

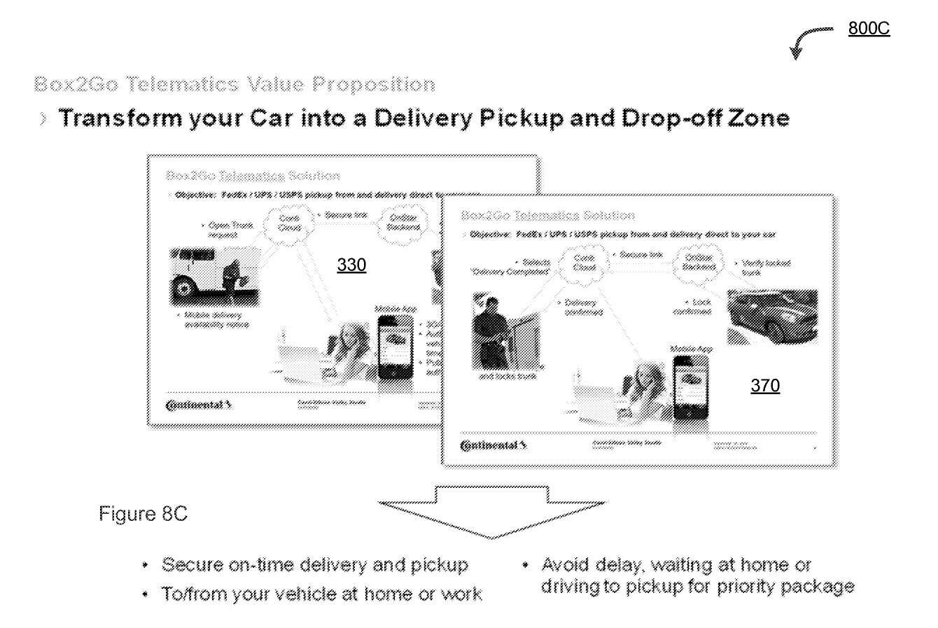

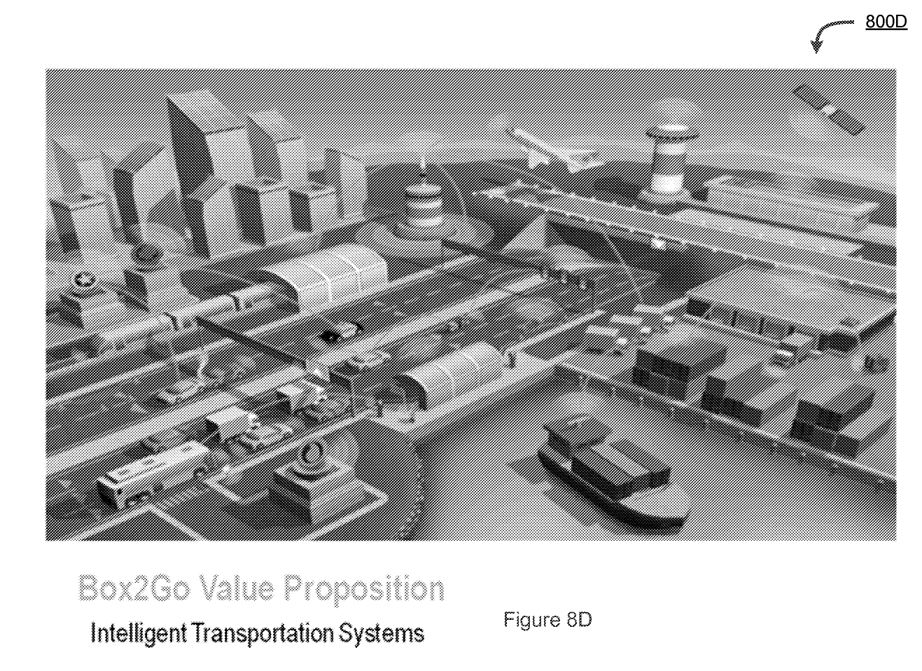

FIGS. 8A-8D illustrate block and flow diagrams of embodiment of the value proposition of the alternative delivery system a compensation module in one of the servers of the package-exchange-with-a-vehicle service. All of these financial models may be stored in one or more databases in the service site. As discussed above, the user/customer may pay an additional fee on a per delivery/per pick-up instance to use the package-exchange-with-a-vehicle service. The user/customer may pay a monthly or yearly subscription fee for all deliveries and pick-ups of packages to use the package-exchange-with-a-vehicle service. The user/customer may pay on another usage case model. A revenue sharing agreement may be in place between any of the retailer, the package-exchange-with-a-vehicle service, the delivery service provider, and the OEM provider. The delivery service may subsidize the delivery of packages to increase volume, make package delivery more efficient, and eliminate re-delivering of packages. For example, in a survey of United Kingdom deliveries, 12% of deliveries failed first time. This costs the delivery industry $1.3 billion in re-deliveries per year. Advertisers may also subsidize the delivery of packages by placement of advertisements in the order placing and delivery process. Many factors such as savings on redelivery costs, efficiency for deliveries, etc. are factored into the financial models. Combinations of the above may be used in the revenue generating processes for using the package-exchange-with-a-vehicle service. The backend servers of the delivery service, the package-exchange-with-a-vehicle service, and retailer sites collect and distribute the compensation.

A compensation module in one of the servers of the package-exchange-with-a-vehicle service is configured to implement a first financial model from two or more financial models stored in the first database. The first financial model uses the database records to track and calculate financial transactions between the package-exchange-with-a-vehicle service and the one or more retail websites. The compensation module in the first server associated with the package-exchange-with-a-vehicle service implements a second financial model to calculate financial transactions between the package-exchange-with-a-vehicle service and the one or more package delivery systems. The compensation module in the first server associated with the package-exchange-with-a-vehicle service implements a third financial model to calculate, based on the database records, financial transactions between the package-exchange-with-a-vehicle service and an alternative set of merchant sites. A fourth financial model may calculate financial transactions between the package-exchange-with-a-vehicle service and one or more cloud based telematics providers.

The compensation module is configured to implement one or more of the financial models that use database records from the package-exchange-with-a-vehicle service to calculate financial transactions between the package-exchange-with-a-vehicle service and the merchant sites, package delivery sites, and/or telematics providers. The compensation module in the first server associated with the package-exchange-with-a-vehicle service calculates financial transactions between the package-exchange-with-a-vehicle service and the retail websites and may be based on a first series of fee agreements between a provider of the package-exchange-with-a-vehicle service and the retail websites. The first series of fee agreements are one or combinations of 1) a subscription agreement with a minimum number of use and then per use charging, 2) a license agreement with unlimited use. The financial model uses the database records to track and calculate financial transactions between the package-exchange-with-a-vehicle service and the one or more merchant websites. The compensation module may calculate the financial transactions between the package-exchange-with-a-vehicle service and the retail websites is based on a second series of fee agreements such as per delivery, monthly subscription service, or other agreement between a provider of the package-exchange-with-a-vehicle service and the retail websites. The compensation module in the first server associated with the package-exchange-with-a-vehicle service calculates financial transactions between the package-exchange-with-a-vehicle service and the cloud based telematics providers based on a second series of fee agreements between the provider of the package-exchange-with-a-vehicle service and the cloud based telematics providers. The second series of fee agreements are one or combinations of 1) a revenue share agreement, 2) a license agreement for unlimited use. The compensation module may also calculate financial transactions between the package-exchange-with-a-vehicle service and the package delivery systems based on a second series of fee agreements between the provider of the package-exchange-with-a-vehicle service and the package delivery systems. The second series of fee agreements may be one or combinations of 1) a revenue share agreement, 2) a license agreement for unlimited use.

The shipping and tracking module is configured to cooperate with the security module to set up the secure package exchange operation.

### Package Pick-Up

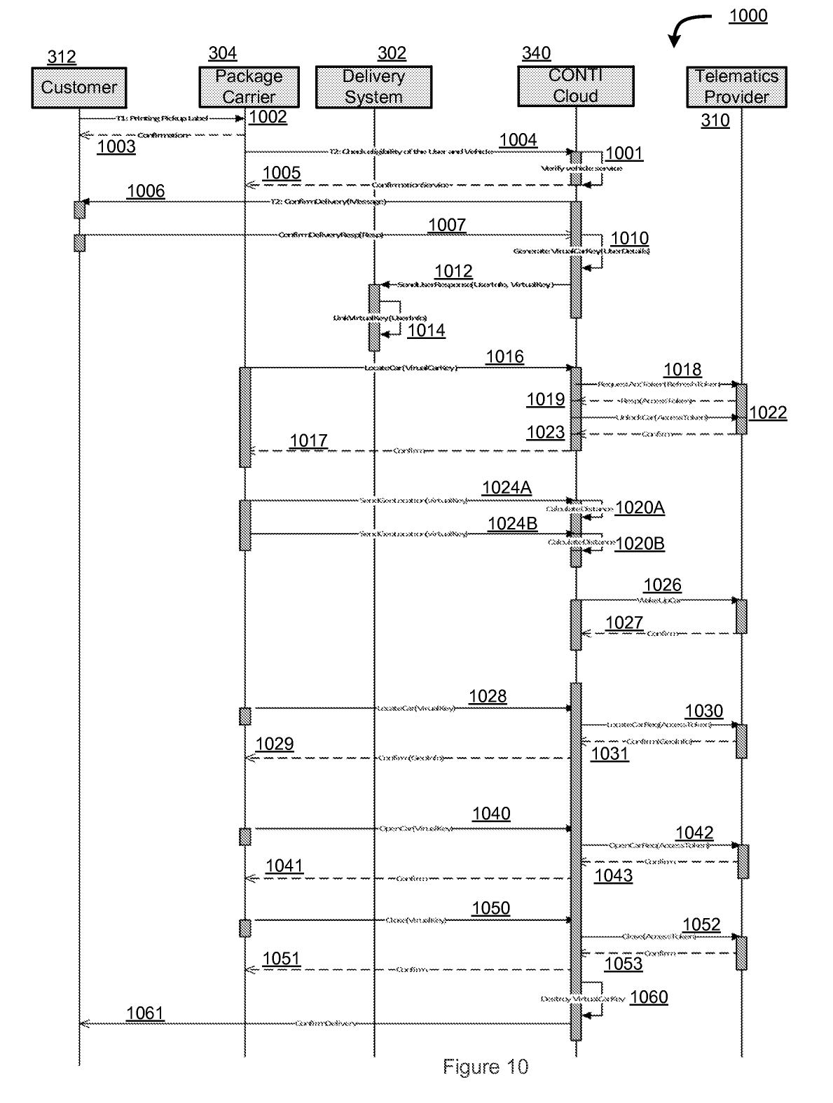

FIG. 10 illustrates a sequence diagram of embodiment of a package pick up from a user of the package-exchange-with-a-vehicle service. A user of the cloud-based package-exchange-with-a-vehicle service can use the Box2Go application resident on their client device to arrange a package pickup from their vehicle. The Box2Go application resident on their client device will collect the details and send the information to the cloud-based package-exchange-with-a-vehicle service. Additionally, and/or alternatively, a package delivery service web site presents a user interface or web page to collect the details for the user to arrange a package pickup from their vehicle.

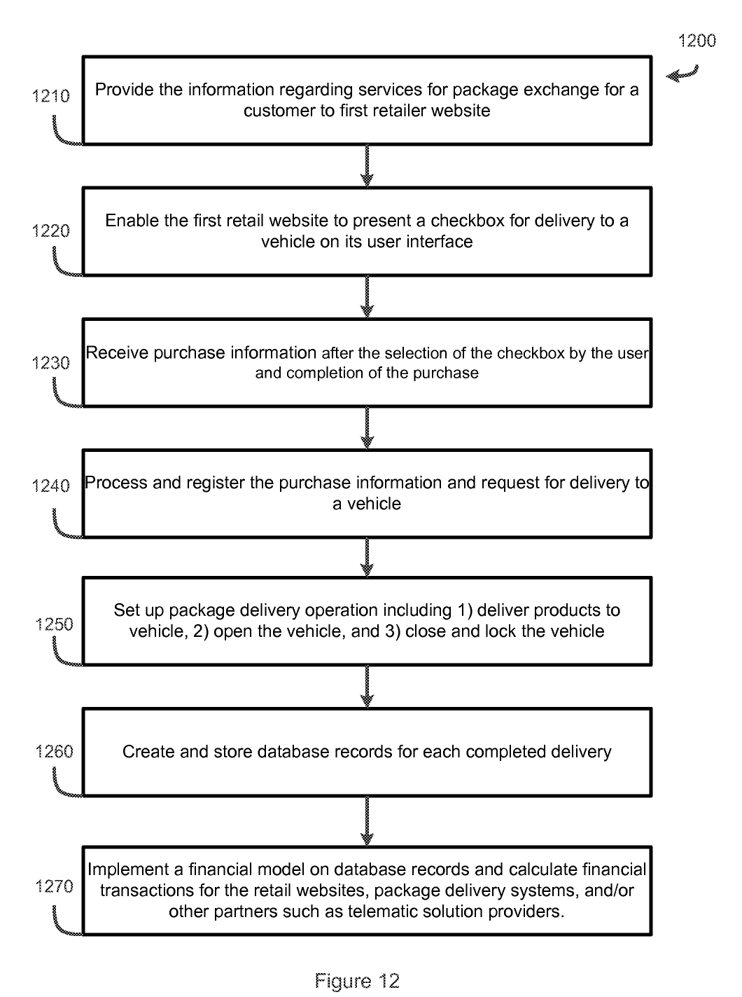

FIG. 12 illustrates a flow graph of an example method of operating a speedy delivery, pick-up, and secure package exchange between a package carrier's vehicle and a target vehicle.

In step 1210, a server of the package-exchange-with-a-vehicle service provide the information regarding services for package exchange for a customer to first retailer website. In step 1220, the information regarding services enables the one or more retail websites to present a checkbox for delivery to a vehicle on its user interface. In step 1230, a server of the package-exchange-with-a-vehicle service receives purchase information after the selection of the checkbox by the user and completion of the purchase from the retail website. In step 1240, a server of the package-exchange-with-a-vehicle service processes and registers the purchase information and request for delivery of a package of purchased goods to a vehicle. In step 1250, a server of the package-exchange-with-a-vehicle service sets up the secure package exchange operation with the customer's target vehicle including 1) deliver products to vehicle, 2) open the vehicle, and 3) close and lock the vehicle. In step 1260, a server of the package-exchange-with-a-vehicle service creates and stores database records for each completed delivery. In step 1260, a server of the package-exchange-with-a-vehicle service implements a financial model on database records and calculate financial transactions for the retail websites, package delivery systems, and/or other partners such as telematic solution providers.

In addition, the method 1200 can be used for describing the sequence of numbered steps in, for example, diagram 300, the flow diagrams 600, 650, 750 in FIGS. 6A, 6B, and 7B, etc. A package transfer is controlled and tracked by a cloud based system (1210). As shown in FIGS. 3A-3C, the package-to-and-from-the-vehicle-service cloud system 340 can control and track a package transfer between a target vehicle 252 and the package delivery vehicle 322.

The current GPS coordinates of the package carrier's vehicle and the GPS coordinates of the target vehicle is transmitted from a GPS-based delivery application resident (1220). For example, as shown in FIGS. 3A-3C, current GPS coordinates of the package carrier's vehicle 322 are calculated. A client device installed in the package carrier's vehicle, or 2) a handheld client device that travels with a driver of a package carrier's vehicle sends using package delivery application 315 of the delivery person 304 the GPS coordinates of the package carrier's vehicle. Similarly, the current GPS coordinates of the target vehicle 252 is received through the Telematics provider 310 after the package-to-and-from-the-vehicle-service cloud system 340 sends a request to the Telematics provider 310 as described above with respect FIG. 3A and 6B.

The telematics module of the target vehicle is woken up at a first proximity distance between the package carrier's vehicle and the target vehicle (1230). As described with respect to FIGS. 3A and 6B, the package-to-and-from-the-vehicle-service cloud system 340 monitors the distance between the package carrier's vehicle 322 and the target vehicle 252. When the distance becomes shorter than a first proximity distance, the package-to-and-from-the-vehicle-service cloud system 340 sends a request to Telematics provider 310 to wake up the target vehicle 252. The wake up calls can be repeated to make sure the target vehicle does not go to sleep mode. In an embodiment the Telematics provider 310 may not send a specific wakeup command but may send another command such as a command to send the GPS coordinates and may repeat this command with intervals shorter than the idle time before going to sleep mode of the Telematics module of the target vehicle to prevent the Telematics module of the target vehicle 252 from going to sleep mode.

An alert is given by the target vehicle at a second proximity distance between the package carrier's vehicle and the target vehicle (1240). The package-to-and-from-the-vehicle-service cloud system 340 continues monitoring the distance between the package carrier's vehicle 322 and the target vehicle 252 and when the distance becomes shorter than a second proximity distance, the package-to-and-from-the-vehicle-service cloud system 340 sends a request to Telematics provider 310 to command the target vehicle 252 to alert the delivery person 304 of the location of the target vehicle by performing one or more actions of honking the horn, flashing the lights, and activating the security system. Additionally or alternatively, the delivery person 304 can initiate a request to the package-to-and-from-the-vehicle-service cloud system 340 for an alert or additional alerts. The alert request is sent by the package-to-and-from-the-vehicle-service cloud system 340 to the Telematics provider 310 where the Telematics provider 310 sends an appropriate command to the target vehicle 252 as described with respect FIG. 3A and 7B.

The target vehicle is unlocked and at least one package is exchanged between the package carrier's vehicle and the target vehicle (1250). As described with respect to FIGS. 3A and 7B, after locating the target vehicle, the delivery person 304 can initiate a request to the package-to-and-from-the-vehicle-service cloud system 340 for unlocking and opening a door of the target vehicle 252. The delivery person 304 can deliver a package to the target car 252 or pick up a package from the target vehicle. The unlock request is sent by the package-to-and-from-the-vehicle-service cloud system 340 to the Telematics provider 310 where the Telematics provider 310 sends an appropriate command to the target vehicle.

A confirmation of the package transfer is received (1260). After the delivery person 304 delivers a package to the target car 252 or picks up a package from the target vehicle 252, secures the car and sends a package transfer confirmation to the package-to-and-from-the-vehicle-service cloud system 340. In an embodiment, the delivery can only close the door or trunk of the target vehicle and locking may be performed by the Telematics provider 310.

The target vehicle is locked after receiving the confirmation (1270). After receiving the package exchange confirmation from the delivery person 304, the package-to-and-from-the-vehicle-service cloud system 340 sends a lock request to the Telematics provider 310 where the Telematics provider 310 sends an appropriate command to the target vehicle to lock the target vehicle 252.

### Computing System

FIG. 1 illustrates a block diagram of an example computing system that may be used in an embodiment of one or more of the servers, in-vehicle electronic modules, and client devices discussed herein. The computing system environment 800 is only one example of a suitable computing environment, such as a client device, server, in-vehicle electronic module, etc., and is not intended to suggest any limitation as to the scope of use or functionality of the design of the computing system 810. Neither should the computing environment 800 be interpreted as having any dependency or requirement relating to any one or combination of components illustrated in the exemplary operating environment 800.

With reference to FIG. 1, components of the computing system 810 may include, but are not limited to, a processing unit 820 having one or more processing cores, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing system 810 typically includes a variety of computing machine readable media. Computing machine readable media can be any available media that can be accessed by computing system 810 and includes both volatile and nonvolatile media, removable and non-removable media. By way of example, and not limitation, computing machine readable mediums uses include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computing device 800. However, carrier waves would not fall into a computer readable medium. Communication media typically embodies computer readable instructions, data structures, program modules, or other transport mechanism and includes any information delivery media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computing system 810, such as during start-up, is typically stored in ROM 831. RAM 832 typically contains data and/or program modules that are immediately accessible to and/or presently being operated on by processing unit 820. By way of example, and not limitation, FIG. 1 illustrates operating system 834, other software 836, and program data 837.

The computing system 810 may also include other removable/non-removable volatile/nonvolatile computer storage media. By way of example only, FIG. 1 illustrates a hard disk drive 841 that reads from or writes to non-removable, nonvolatile magnetic media nonvolatile optical disk 856 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 1, provide storage of computer readable instructions, data structures, other software and other data for the computing system 810. In FIG. 1, for example, hard disk drive 841 is illustrated as storing operating system 844, other software 846, and program data 847. Note that these components can either be the same as or different from operating system 834, other software 836, and program data 837. Operating system 844, other software 846, and program data 847 are given different numbers here to illustrate that, at a minimum, they are different copies.

A user may enter commands and information into the computing system 810 through input devices such as a keyboard 862, a microphone 863, a pointing device 861, such as a mouse, trackball or touch pad. The microphone 863 may cooperate with speech recognition software. These and other input devices are often connected to the processing unit 820 through a user input interface 860 that is coupled to the system bus, but may be connected by other interface and bus structures, such as a parallel port, game port or a universal serial bus (USB). A display monitor 891 or other type of display screen device is also connected to the system bus 821 via an interface, such as a video interface 890. In addition to the monitor, computing devices may also include other peripheral output devices such as speakers 897 and other output device 896, which may be connected through an output peripheral interface 890.

The computing system 810 may operate in a networked environment using logical connections to one or more remote computers/client devices, such as a remote computing device 880. The remote computing device 880 may be a personal computer, a hand-held device, a server, a router, a network PC, a peer device or other common network node, and typically includes many or all of the elements described above relative to the computing system 810. The logical connections depicted in FIG. 1 include a local area network (LAN) 871 and a wide area network (WAN) 873, but may also include other networks. Such networking environments are commonplace in offices, enterprise-wide computer networks, intranets and the Internet. A browser application may be resident on the computing device and stored in the memory.

When used in a LAN networking environment, the computing system 810 is connected to the LAN 871 through a network interface or adapter 870. When used in a WAN networking environment, the computing system 810 typically includes a modem 872 or other means for establishing communications over the WAN 873, such as the Internet. The modem 872, which may be internal or external, may be connected to the system bus 821 via the user-input interface 860, or other appropriate mechanism. In a networked environment, other software depicted relative to the computing system 810, or portions thereof, may be stored in the remote memory storage device. By way of example, and not limitation, FIG. 1 illustrates remote application programs 885 as residing on remote computing device 880. It will be appreciated that the network connections shown are exemplary and other means of establishing a communications link between the computing devices may be used.

As discussed, the computing system may include a processor, a memory, a built in battery to power the computing device, an AC power input, potentially a built-in video camera, a display screen, a built-in Wi-Fi circuitry to wirelessly communicate with a remote computing device connected to network.

It should be noted that the present design can be carried out on a computing system such as that described with respect to FIG. 1. However, the present design can be carried out on a server, a computing device devoted to message handling, or on a distributed system in which different portions of the present design are carried out on different parts of the distributed computing system.

Another device that may be coupled to bus 811 is a power supply such as a battery and Alternating Current adapter circuit. As discussed above, the DC power supply may be a battery, a fuel cell, or similar DC power source that needs to be recharged on a periodic basis. The wireless communication module 872 may employ a Wireless Application Protocol to establish a wireless communication channel. The wireless communication module 872 may implement a wireless networking standard such as Institute of Electrical and Electronics Engineers (IEEE) 802.11 standard, IEEE std. 802.11-1999, published by IEEE in 1999.

Examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

Vehicle's Intelligent Transport Systems to Integrate with a Connected Network Environment

A vehicle has hardware and software that can take control of the vehicle for a short period including activating electromechanical mechanisms that are part of the vehicle, such as a RF access module, a key fob module, and/or a BCM module. The vehicle may have hardware and software for networking between the cloud as well as potentially between other vehicles to cause related automation within the vehicle based on communications between the vehicle and the cloud and/or other vehicles. The vehicle's Cellular Interface system is configured to allow cellular phones access the automobile computer systems, interpret the information and show the text on the cellular phones display while simultaneously transmitting the retrieved information, as well as characteristic and states of the cellular phone used to access the vehicle computer system, to a global network that would alert parties who could assist or benefit from the retrieved automobile information. A cellular phone with a software application can establish a connection with the vehicle's on-board diagnostic computer and/or other on-board intelligent control systems.

The system can interface with a client device, such as a mobile phone, with the on-board computing system in the vehicle. The on-board diagnostic computing device may monitor a set of operational characteristics of a vehicle and communicate that diagnostic to both the driver and with the cloud. The information derived from this system can also be conveyed and processed on a mobile client device coupled with additional information and displayed on the mobile client device's display screen, while simultaneously transmitting this information over the Internet to be stored in a database.

At the point of communication negotiation, an application on the client device extracts position location from the vehicle's navigation system and transmits the response from the vehicle's navigation system and the location to a server ready to receive this information. Alternatively, an application can extract similar position information from GPS module internal to the client device itself.

In an embodiment, the standard for the automotive industry for vehicles may use is the SAE J1850 communications protocol, which utilizes variable pulse width modulation and pulse width modulation. This means that the width of the pulse determines whether it is a 1 or a 0. Most phones form communication with serial connections (RS-232, Infrared . . . etc.) and wireless connection protocols (Bluetooth, Infrared . . . etc.). These two protocols must be converted or bridged by some sort of microprocessor so the two communication methodologies can communicate with each other. This can be accomplished by using an integrated circuit that can be used to convert the OBD-II signal (which includes different protocols such as, but not limited to: J1850 VPW, J1850 PWM, ISO 9141-2, ISO 14230, ISO 15765) to one of the aforementioned phone communication formats.

### Network Environment

FIGS. 2A-2B illustrate block diagrams of embodiments of the package-exchange-with-a-vehicle service hosted on a cloud-based provider site. The cloud-based package-exchange-with-a-vehicle service is hosted on a cloud-based provider site that contains one or more servers and one or more databases. FIG. 2A illustrates diagram 200 of a network environment in which the techniques described may be applied. The network environment 200 has a communications network 220 that connects server computing systems 204A through 204E, and at least one or more client computing systems 202A, 202B. As shown, there may be many server computing systems 204A through 204E and many client computing systems 202A through 202B connected to each other via the network 220, which may be, for example, the Internet. Note, that alternatively the network 220 might be or include one or more of: an optical network, the Internet, a Local Area Network (LAN), Wide Area Network (WAN), satellite link, fiber network, cable network, or a combination of these and/or others. It is to be further appreciated that the use of the terms client computing system and server computing system is for clarity in specifying who generally initiates a communication (the client computing system) and who responds (the server computing system). No hierarchy is implied unless explicitly stated. Both functions may be in a single communicating device, in which case the client-server and server-client relationship may be viewed as peer-to-peer. Thus, if two systems such as the client computing system 202A and the server computing system 204A can both initiate and respond to communications, their communication may be viewed as peer-to-peer. Likewise, communications between the client computing systems 204A and 204-2, and the server computing systems 202A and 202B may be viewed as peer-to-peer if each such communicating device is capable of initiation and response to communication. Additionally, server computing systems 204A-204E also have circuitry and software to communication with each other across the network 220. One or more of the server computing systems 204A to 204E may be associated with a database such as, for example, the databases 206A to 206E. Each server may have one or more instances of a virtual server running on that physical server and multiple virtual instances may be implemented by the design. A firewall may be established between a client computing system 200A and the network 220 to protect data integrity on the client computing system 200A. Each server computing system 204A-204E may have one or more firewalls.

FIG. 2B illustrates block diagram 250 of an embodiment of the package-exchange-with-a-vehicle service hosted on a cloud-based provider site. The web server farm 270 may have examples of 4 servers coupled to databases 275 which may have examples of 2 database clusters. A user can download and use either i) a vehicle package delivery/pickup mobile application 254 or ii) a vehicle package delivery/pickup desktop application 350 on their client device to register with the package-to-and-from-the-vehicle-service cloud system 340 (see, for example, FIG. 3B). The cloud-based package-exchange-with-a-vehicle service hosted on a cloud-based provider site contains one or more servers and one or more databases. The one or more databases store at least i) User ID and Password for the package-exchange-with-a-vehicle service, ii) User name, iii) email or contact phone number of the user, iv) Security questions, v) Vehicle VIN, vi) Vehicle make, model, color, year, and vii) any combination of at least three of these. In one embodiment, the cloud based network 260 is configured to communication with 1) a user's mobile application 254, 2) a retailer website 258, 3) a telematics module of vehicle 252, via a secure connection 256 from a telematics provider to vehicle 252, and 4) a package delivery vehicle 262. The cloud based network 260 includes/is coupled to servers 270 which are protected by an external firewall 264 from the users and providers. The cloud based network 260 also includes/is coupled to databases 275 which are protected by an internal firewall 266 from the servers 270.

A cloud provider service can install and operate application software in the cloud and users can access the software service from the client devices. Cloud users who have a site in the cloud may not solely manage the cloud infrastructure and platform where the application runs. Thus, the servers and databases may be shared hardware where the user is given a certain amount of dedicate use of these resources. The user's cloud based site is given a virtual amount of dedicated space and bandwidth in the cloud. Cloud applications can be different from other applications in their scalability—which can be achieved by cloning tasks onto multiple virtual machines at run-time to meet changing work demand. Load balancers distribute the work over the set of virtual machines. This process is transparent to the cloud user, who sees only a single access point.

The cloud-based package-exchange-with-a-vehicle service is coded to utilize a protocol, such as Hypertext Transfer Protocol (HTTP), to engage in a request and response cycle with both a mobile device application resident on a client device as well as a web-browser application resident on the client device. The cloud-based package-exchange-with-a-vehicle service has one or more routines to automate a package delivery to and pick up from the vehicle process. The cloud-based package-exchange-with-a-vehicle service can be accessed by a mobile device, a desktop, a tablet device and other similar devices, anytime, anywhere. Thus, the cloud-based package-exchange-with-a-vehicle service hosted on a cloud-based provider site is coded to engage in 1) the request and response cycle from all web browser based applications, 2) SMS/twitter based request and response message exchanges, 3) the request and response cycle from a dedicated on-line server, 4) the request and response cycle directly between a native mobile application resident on a client device and the cloud-based package-exchange-with-a-vehicle service, and 5) combinations of these.

The cloud-based package-exchange-with-a-vehicle service has one or more application programming interfaces (APIs) with two or more of the package delivery entity sites, such as FedEx, UPS, etc., as well as application programming interfaces with two or more of the OEM ‘remote access/connectivity’ systems, such as telematics system sites, such as OnStar, Lexus Linksys, Ford Sync, Uconnect, MBConnect, BMW Connect, etc. The APIs may be a published standard for the connection to each OEM ‘remote access/connectivity’ system. The APIs may also be an open source API. One or more of the API's may be customized to closed/non-published APIs of a remote access/connectivity’ site and/or package delivery entity site. The cloud-based package-exchange-with-a-vehicle service is coded to establish a secure communication link between each package delivery entity site and the cloud provider site. The cloud-based package-exchange-with-a-vehicle service is coded to establish a secure communication link between each telematics system site and the cloud provider site. The software service is coded to establish the secure communication link by creating a tunnel at the socket layer and encrypting any data while in transit between each package delivery entity sites and the provider site as well as to satisfy any additional authentication mechanisms required by the direct lending institution, including but not limited to IP address white listing and token based authentication.

In an embodiment, the server computing system 204 may include a server engine, a web page management component, a content management component and a database management component. The server engine performs basic processing and operating system level tasks. The web page management component handles creation and display or routing of web pages or screens associated with receiving and providing digital content and digital advertisements. Users may access the server-computing device by means of a URL associated therewith. The content management component handles most of the functions in the embodiments described herein. The database management component includes storage and retrieval tasks with respect to the database, queries to the database, and storage of data. Each server may have one or more ports as points of ingress and egress.

An embodiment of a server computing system to display information, such as a web page, etc. An application including any program modules, when executed on the server computing system 204A, causes the server computing system 204A to display windows and user interface screens on a portion of a media space, such as a web page. A user via a browser from the client computing system 200A may interact with the web page, and then supply input to the query/fields and/or service presented by a user interface of the application. The web page may be served by a web server computing system 204A on any Hypertext Markup Language (HTML) or Wireless Access Protocol (WAP) enabled client computing system 202A or any equivalent thereof. For example, the client mobile computing system 202A may be a smart phone, a touch pad, a laptop, a netbook, etc. The client computing system 202A may host a browser to interact with the server computing system 204A. Each application has a code scripted to perform the functions that the software component is coded to carry out such as presenting fields and icons to take details of desired information. Algorithms, routines, and engines within the server computing system 204A take the information from the presenting fields and icons and put that information into an appropriate storage medium such as a database. A comparison wizard is scripted to refer to a database and make use of such data. The applications may be hosted on the server computing system 204A and served to the browser of the client computing system 202A. The applications then serve pages that allow entry of details and further pages that allow entry of more details.

### Telematics System

The telematics system uses telecommunications, vehicular technologies, electrical sensors, instrumentation, and wireless communications modules to allow communication with between the cloud and a vehicle. The telematics system site sends, receives and stores information via a telematics module to affect control on objects in the vehicle. Telematics includes but is not limited to Global Positioning System technology integrated with computers and mobile communications technology in automotive navigation systems. Telematics also includes cloud-based interaction with an integrated hands-free cell phone system in the vehicle, wireless safety communication system in the vehicle, and automatic driving assistance systems.

A wireless communication circuit exchanges communication between the mobile client device and the vehicle. The wireless communication circuit executes instructions with the processor via a bus system. The wireless communication circuit can be configured to communicate to RF (radio frequency), satellites, cellular phones (analog or digital), Bluetooth®V, Wi-Fi, Infrared, Zigby, Local Area Networks (LAN), WLAN (Wireless Local Area Network), or other wireless communication configurations and standards. The wireless communication circuit allows the vehicle's intelligence systems such as the telematics module and other diagnostic tools to communicate with other devices wirelessly. The wireless communication circuit includes an antenna built therein and being housed within the housing or can be externally located on the housing.

The Telecommunications and Informatics applied in wireless technologies and computational systems may be based on 802.11p. The IEEE standard in the 802.11 family and also referred to as Wireless Access for the Vehicular Environment (WAVE) is the primary standard that addresses and enhances Intelligent Transportation System.

An example telematics module sends commands and exchanges information other electronic circuits, electromechanical devices, and electromagnetic devices in the vehicle. The telematics module may operate in conjunction with computer-controlled devices and radio transceivers to provide precision repeatability functions (such as in robotics artificial intelligence systems) and emergency warning performance systems located in and exchanged between vehicles.

Additional intelligent vehicle technologies are car safety systems and self-contained autonomous electromechanical sensors to generate warnings that can be transmitted within a specified targeted area of interest, say within 100 meters of the emergency warning system for vehicles transceiver. In ground applications, intelligent vehicle technologies are utilized for safety and commercial communications between vehicles or between a vehicle and a sensor along the road.

The wireless communication circuits in the vehicle or in a client device are configured to give access to the mobile Internet via a cellular telephone service provider. The mobile Internet is wireless access that handoffs the mobile client device or vehicle from one radio tower to another radio tower while the vehicle or device is moving across the service area. Also, in some instances Wi-Fi may be available for users on the move so that a wireless base station connects directly to an Internet service provider, rather than through the telephone system.

### Scripted Code

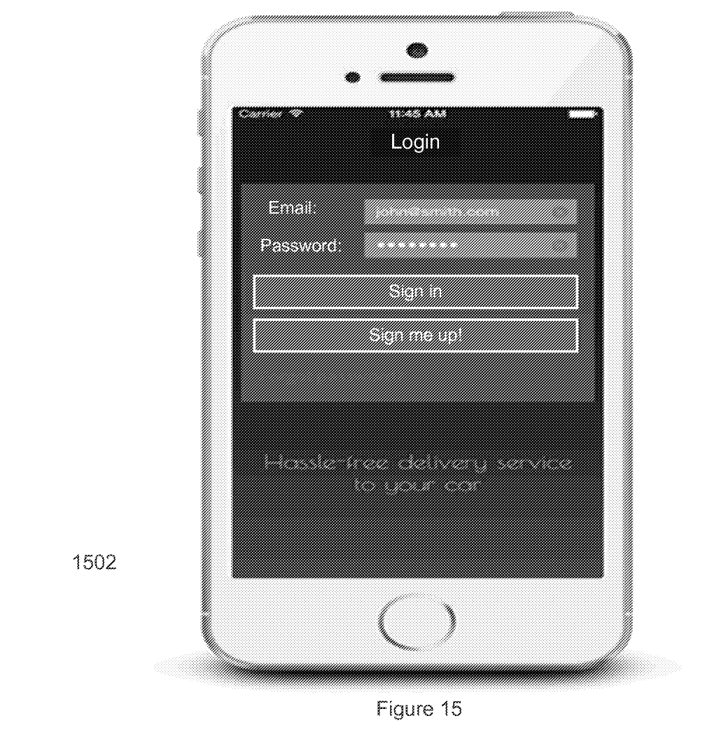

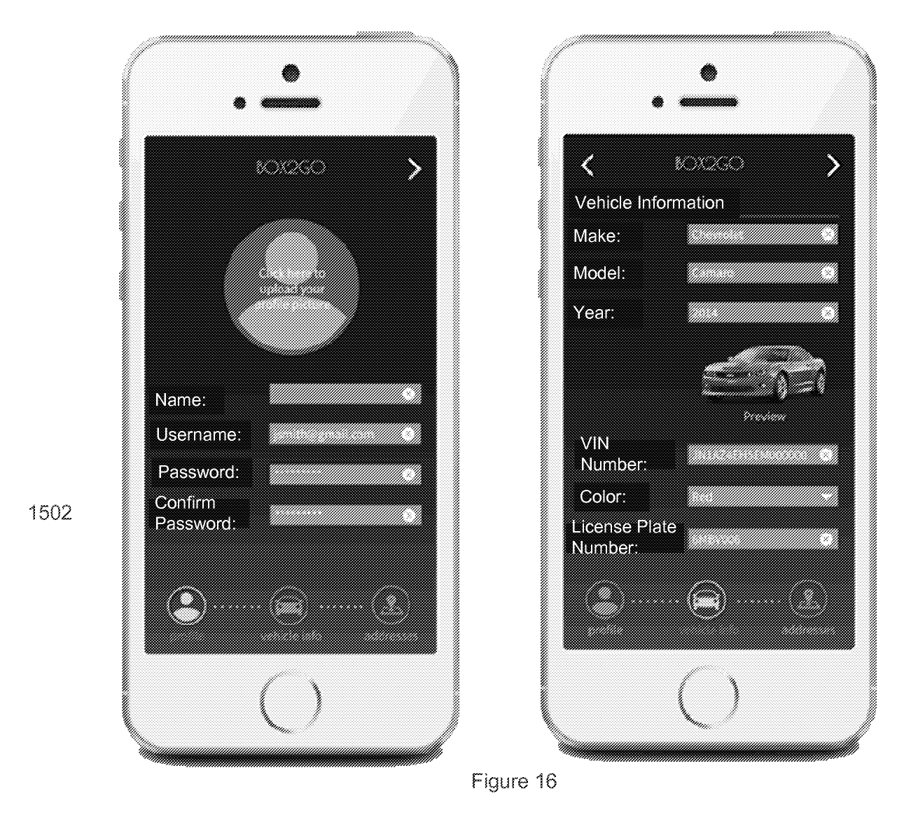

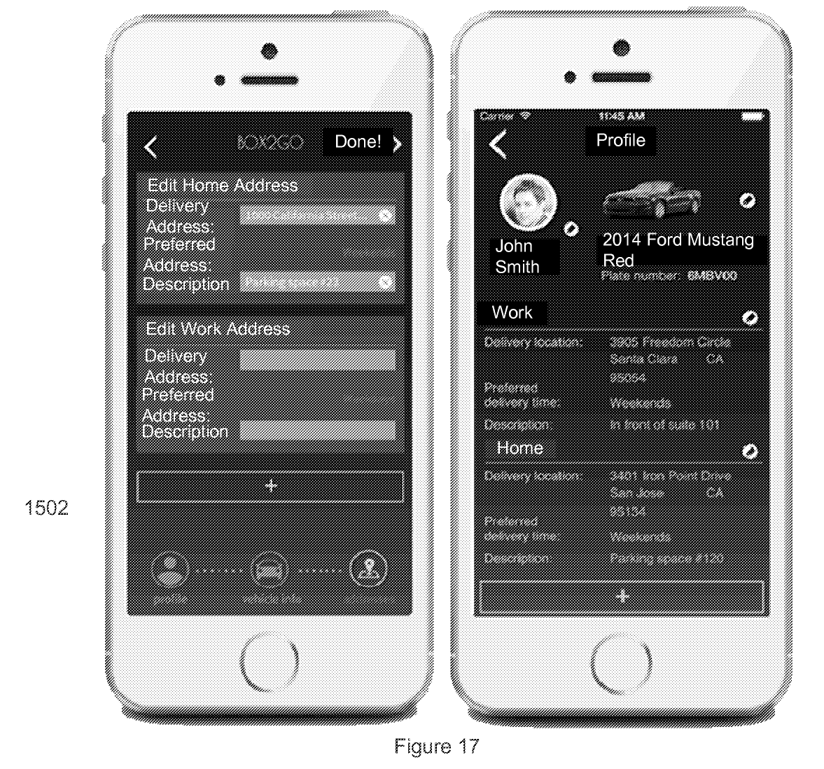

FIGS. 15-17 illustrate diagrams of an application of a package exchange service with a vehicle on a client device used to coordinate a secure package exchange for packages from a plurality of merchant sites. The various methods and processes discussed herein can be implemented with the aid of the application of a package exchange service with a vehicle 1502 resident on a user's/customer's client device.

In regards of viewing ability of an on-line site: the scripted code for the on-line site, such as a website, social media site, etc., is configured to adapted to be i) viewed on tablets and mobile phones, such as individual downloadable applications in data stores that are designed to interface with the on-line site, ii) viewable on a screen in the vehicle, as well as iii) viewable on a screen of a desktop computer via a browser. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like.

Mobile web applications and native applications can be downloaded from a cloud-based site. The mobile web applications and native applications have direct access to the hardware of mobile devices (including accelerometers and GPS chips), and the speed and abilities of browser-based applications. Information about the mobile phone and the vehicle's location is gathered by software housed on the phone.

One or more scripted routines for the cloud-based package-exchange-with-a-vehicle service are configured to collect and provide features such as those described herein.

Any application and other scripted code components may be stored on a non-transitory computing machine readable medium which, when executed on the server causes the server to perform those functions. The applications including program modules may be implemented as logical sequences of software code, hardware logic circuits, and any combination of the two, and portions of the application scripted in software code are stored in a non-transitory computing device readable medium in an executable format. In an embodiment, the hardware logic consists of electronic circuits that follow the rules of Boolean Logic, software that contain patterns of instructions, or any combination of both.

The design is also described in the general context of computing device executable instructions, such as applications etc. being executed by a computing device. Generally, software includes routines, programs, objects, widget, plug-ins, and other similar structures that perform particular tasks or implement particular abstract data types. Those skilled in the art can implement the description and/or figures herein as computer-executable instructions, which can be embodied on any form of computing machine readable media discussed herein.

Some portions of the detailed descriptions herein are presented in terms of algorithms/routines and symbolic representations of operations on data bits within a computer memory. These algorithmic descriptions and representations are the means used by those skilled in the data processing arts to most effectively convey the substance of their work to others skilled in the art. An algorithm/routine is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms/routine of the application including the program modules may be written in a number of different software programming languages such as C, C++, Java, HTML, or other similar languages.

Many online pages on a server, such as web pages, are written using the same language, Hypertext Markup Language (HTML), which is passed around using a common protocol—HTTP. HTTP is the common Internet language (dialect, or specification). Through the use of a web browser, a special piece of software that interprets HTTP and renders HTML into a human-readable form, web pages authored in HTML on any type of computer can be read anywhere, including telephones, PDAs and even popular games consoles. Because of HTTP, a client machine (like your computer) knows that it has to be the one to initiate a request for a web page; it sends this request to a server. A server may be a computing device where web sites reside—when you type a web address into your browser, a server receives your request, finds the web page you want, and sends it back to your desktop or mobile computing device to be displayed in your web browser. The client device and server may bilaterally communicate via a HTTP request & response cycle between the two.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computing system, or similar electronic computing device, that manipulates and transforms data represented as physical (electronic) quantities within the computing system's registers and memories into other data similarly represented as physical quantities within the computing system memories or registers, or other such information storage, transmission or display devices.

Although embodiments of this design have been fully described with reference to the accompanying drawings, it is to be noted that various changes and modifications will become apparent to those skilled in the art. Such changes and modifications are to be understood as being included within the scope of embodiments of this design as defined by the appended claims. The invention is to be understood as not limited by the specific embodiments described herein, but only by scope of the appended claims.

What is claimed is:

1. A cloud based package exchange system, comprising:
a cloud based package-exchange-with-a-vehicle service is hosted on a cloud based provider site that includes one or more servers each having one or more processors and are configured to store and retrieve information with one or more databases in the cloud based provider site, where one or more of the servers of the cloud based package-exchange-with-a-vehicle service are configured to supply servers and databases of one or more retail websites with information regarding services for a package exchange available to one or more customers and associated vehicles of the customers, where a first module in a first server associated with the package-exchange-with-a-vehicle service is configured to provide the information regarding the services for the package exchange with a vehicle of a customer to a second server of a first retail website, the information regarding services includes one or more package delivery systems with their servers that are set up to cooperate with the servers of the package-exchange-with-a-vehicle service to deliver one or more purchased products from the first retail website to an associated target vehicle of the customer, where the information regarding services which is sent from the first server of the package-exchange-with-a-vehicle service to the second server of the first retail website enables the first retail website to present a button on a user interface of a shopping application resident on a first client device of the customer, the first client device is coupled to the first retail website for purchasing products from the first retail website, where the presented button is configured to enable the customer at a checkout point of the purchase from the first retail website, to select an alternative package delivery option of delivering the one or more purchased products to the associated target vehicle of the customer;
a shipping and tracking module in the first server associated with the package-exchange-with-a-vehicle service is configured to communicate with the second server of the first retail website to receive purchase information after the checkout point and completion of the purchase by the customer, the purchase information includes information regarding the customer including their name, and the target vehicle of the customer, at least a first package delivery system that is set up to exchange the purchased products with the target vehicle of the customer, and an expected delivery date and delivery location, where the purchase information is stored in the one or more databases in the cloud based provider site, wherein the shipping and tracking module is configured to cooperate with at least a first database and a first processor of the cloud based provider site to process information including a shipping Tracking Number (TN) and a Vehicle Identification Number (VIN) of the target vehicle associated with the purchase and to register the purchase information and a request for package delivery to the target vehicle of the customer in one of the databases of the cloud based provider site associated with the package-exchange-with-a-vehicle service;
a security module in the first server associated with the package-exchange-with-a-vehicle service is configured to setup a package delivery operation including 1) a first routine to direct delivery of the one or more purchased products to the associated target vehicle of the customer, 2) a second routine to open and/or unlock the target vehicle of the customer to ensure the one or more purchased products can be delivered, 3) a third routine to ensure the one or more purchased products have been delivered, and 4) a forth routine to ensure, after delivery of the purchased products, the target vehicle of the customer is closed and locked;
a compensation module in one of the servers of the package-exchange-with-a-vehicle service is configured to implement a first financial model from two or more financial models stored in the first database, the first financial model uses the database records to track and calculate financial transactions between the package-exchange-with-a-vehicle service and the one or more retail websites; and
wherein the cloud based package-exchange-with-a-vehicle service can be implemented in software, hardware electronics, and any combination of both, and when one or more portions of the package-exchange-with-a-vehicle service including portions of the modules are implemented in software then the software is tangibly stored in an executable format on one or more non-transitory storage mediums and executed by at least one of the processors.

2. The system of claim 1, wherein the shipping and tracking module in the first server associated with the package-exchange-with-a-vehicle service is configured to send notices to a package exchange application resident in the first client device of the customer, the notices including:
an expected delivery notice having a date and time of delivery to the target vehicle of the customer, and
a confirmation notice of completion of delivery operation to the target vehicle of the customer; and
wherein the compensation module in the first server associated with the package-exchange-with-a-vehicle service implements a second financial model to calculate financial transactions between the package-exchange-with-a-vehicle service and the one or more package delivery systems.

3. The system of claim 1, further including:
a GPS-based proximity module in the security module associated with the package-exchange service configured to receive both current GPS coordinates of a package delivery vehicle and current GPS coordinates of the target vehicle of the customer for at least one of i) package delivery to the target vehicle of the customer and ii) package pick up from the target vehicle of the customer, and wherein the GPS-based proximity module is further configured to monitor a distance between the package delivery vehicle and the target vehicle of the customer and in cooperation with the security module to send to an onboard actuation module in the target vehicle of the customer one or more commands 1) to wake-up the onboard actuation module in the target vehicle of the customer while in a close proximity established by a first threshold distance between the package delivery vehicle and the target vehicle of the customer, 2) to give an alert from the target vehicle of the customer while in a close proximity established by a second threshold distance between the package delivery vehicle and the target vehicle of the customer, 3) to unlock a door including a trunk of the target vehicle of the customer, and 4) established by a fourth threshold distance to lock the doors of the target vehicle of the customer after receiving a confirmation of the package delivery operation from a second client device associated with the package delivery vehicle;
wherein the GPS-based proximity module of the security module is configured to receive the current GPS coordinates of the package delivery vehicle from the second client device in the package delivery vehicle and the current GPS coordinates of the target vehicle of the customer from one of 1) the onboard actuation module installed in the target vehicle of the customer, or 2) the first client device of the customer; and
wherein the onboard actuation module is one of i) an onboard telematics module installed in the target vehicle of the customer and configured to communicate with a cloud based server associated with the package-exchange-with-a-vehicle service through a cloud based telematics provider, ii) a key fob access module installed in the target vehicle, or iii) a dongle module having a Wi-Fi or cellular communication circuit configured to establish a secure communication with the cloud based server associated with the package-exchange-with-a-vehicle service, where the dongle is also coupled to an electro-mechanical activation circuit configured to cooperate with a fault and diagnostic module installed in the target vehicle of the customer to retrieve diagnostic data including the GPS coordinates of the target vehicle of the customer.

4. The system of claim 3, further comprising:
a fourth module in one of the servers in the package-exchange-with-a-vehicle service is configured to use the registered purchase information and to create one or more database records for each completed delivery operation, where the fourth module is configured to cooperate with the shipping and tracking module to send a notice to any of i) the second server of the first retail website, ii) the first client device of the customer, and iii) any combination of both, which the notice conveys to the customer associated with the target vehicle confirmation that the package exchange has in fact occurred, where the database records of deliveries are stored in the first database to keep track of deliveries;
wherein the security module in the first server associated with the package-exchange-with-a-vehicle service is configured to communicate with a client device of the package delivery service to the onboard key fob access module of the target vehicle of the customer, the package delivery operation includes sending commands for 1) giving an alert by the target vehicle of the customer, 2) opening the target vehicle of the customer and 3) ensuring the target vehicle of the customer is closed and locked after delivery;
wherein the GPS-based proximity module of the first server associated with the package-exchange-with-a-vehicle service is configured to receive the current GPS coordinates of the target vehicle of the customer from an onboard module of the target vehicle or from an application resident in a smart phone of the customer; and
wherein the compensation module in the first server associated with the package-exchange-with-a-vehicle service implements a third financial model to calculate, based on the database records, financial transactions between the package-exchange-with-a-vehicle service and the package delivery service.

5. The system of claim 4, wherein the compensation module in the first server associated with the package-exchange-with-a-vehicle service calculates financial transactions between the package-exchange-with-a-vehicle service and the retail websites based on a first series of fee agreements between a provider of the package-exchange-with-a-vehicle service and the retail websites, where the first series of fee agreements are one or combinations of 1) a subscription agreement with a minimum number of use and then per use charging, 2) a license agreement with unlimited use;
wherein the compensation module in the first server associated with the package-exchange-with-a-vehicle service calculates financial transactions between the package-exchange-with-a-vehicle service and the cloud based telematics providers based on a second series of fee agreements between the provider of the package-exchange-with-a-vehicle service and the cloud based telematics providers, where the second series of fee agreements are one or combinations of 1) a revenue share agreement, 2) a license agreement for unlimited use.

6. The system of claim 1, wherein before sending commands to the target vehicle of the customer, the security module in the first server associated with the package-exchange-with-a-vehicle service receives at least two virtual verification keys, a first virtual verification key from a second client device associated with a package delivery vehicle and a second virtual verification key from the first client device of the customer;
wherein the first virtual verification key is given a first shelf life and the second virtual verification key is given a second shelf life such that sending of the commands stay within an overlap window of time between the first shelf life and the second shelf life;
wherein the first virtual key is a public key selected from a pool of virtual keys in the first database associated with the package-exchange-with-a-vehicle service and provided through the first package delivery system to the second client device of the package delivery vehicle, the pool of virtual keys including one or more public keys and associated private keys, where the received first virtual key is used by the security module of the first server associated with the package-exchange-with-a-vehicle service to authenticate communications received from the package delivery vehicle;
wherein the second virtual key is received from the first client device of the customer, the second virtual key is either 1) a token supplied by a telematics provider to the first client device of the customer and then by the first client device of the customer to the security module, where the security module is configured to send the security token and one or more commands to the telematics provider, where the security token is used by a verification module of the telematics provider to verify the customer and the target vehicle of the customer before sending the command to an onboard telematics module of the target vehicle, or 2) a first rolling security key of a Body Control Module (BCM) of the target vehicle of the customer, where the first rolling security key is used by the security module of the first server associated with the package-exchange-with-a-vehicle service to generate a next second rolling security key for the BCM of the target vehicle of the customer to be used by a delivery person of the package delivery vehicle via a universal key fob simulator for sending the commands including lock and unlock commands to the BCM of the target vehicle of the customer.

7. The system of claim 3, wherein the security module in the first server associated with the package-exchange-with-a-vehicle service is configured to command the onboard actuation module in the target vehicle of the customer via using Wi-Fi or cellular communication to establish a secure communication with the onboard actuation module and to send commands including the lock and unlock commands and one or more rolling security keys of a Body Control Module of the target vehicle of the customer to the onboard actuation module;
wherein the onboard actuation module includes a Radio Frequency circuitry of a key fob entry system, where after receiving the commands and the rolling security keys, the onboard actuation module communicates RF signals including the commands and rolling security keys to the Body Control Module of the target vehicle of the customer to perform mechanical operations including locking and unlocking of the target vehicle.

8. The system of claim 1, wherein the security module in the first server associated with the package-exchange-with-a-vehicle service is configured to send commands including the lock and unlock commands and one or more rolling security keys of a Body Control Module of the target vehicle of the customer to a second client device associated with a package delivery vehicle, where a delivery person uses a key fob simulator to transmit RF signals including commands and rolling security keys to the Body Control Module of the target vehicle of the customer to perform mechanical operations including locking and unlocking of the target vehicle.

9. The system of claim 1, wherein the first module in the first server associated with the package-exchange-with-a-vehicle service is configured to receive one or more customer verification requests from the servers of the one or more retail websites;
wherein in response to a first customer verification request from the first retail website, the first module is configured 1) to provide a login screen for the customer of the first retail website, where the shopping application resident on the first client device of the customer is redirected from the first retail website to the login screen of the cloud based provider site of the package-exchange-with-a-vehicle service to enter customer credentials corresponding to a customer's account of the package-exchange-with-a-vehicle service, or 2) to receive from the second server of the first retail website, the customer credentials corresponding to the customer's account of the package-exchange-with-a-vehicle service; and
wherein after the customer verification based on the customer credentials including a username and a password and zero or more security questions, the first module provides a response to the second server of the first retail website, where the response includes information regarding the services for package exchange available to the customer and the target vehicle associated with the customer, the package delivery systems that can deliver the purchased products from the first retail website to the associated target vehicle of the customer, and a vehicle identification number of the target vehicle of the customer.

10. The system of claim 9, wherein the package exchange application resident on the first client device of the customer is configured to allow the customer to login to the customer's account of the package-exchange-with-a-vehicle service in order to track the delivery of the purchased products.

11. A method to facilitate a package exchange with a vehicle via a cloud based package-exchange-with-a-vehicle service, comprising:
hosting the cloud based package-exchange-with-a-vehicle service on a cloud based provider site that includes one or more servers each having one or more processors, where the servers store and retrieve information with one or more databases of the cloud based provider site;
configuring the servers of the cloud based package-exchange-with-a-vehicle service to provide servers and databases of one or more retail websites with information regarding services for a package exchange available to one or more customers and associated vehicles of the customers;
providing by a first module in a first server associated with the package-exchange-with-a-vehicle service the information regarding the services for package exchange with a vehicle of a customer to a second server of a first retail website, the information including one or more package delivery systems that can deliver purchased products from the first retail website to an associated target vehicle of the customer;
enabling the first retail website to present a button on a user interface of a shopping application resident on a first client device of the customer, the first client device is coupled to the first retail website for purchasing products from the first retail website, the button enables the customer at a checkout point of the purchase from the first retail website, to select an alternative package delivery option of delivering the purchased products to the associated target vehicle of the customer;
receiving by a shipping and tracking module in the first server associated with the package-exchange-with-a-vehicle service, purchase information after a checkout point and completion of the purchase by the customer when at the checkout point the customer selects the button for an alternative package delivery option to the associated target vehicle of the customer, the purchase information includes information of the customer and the target vehicle of the customer, at least a first package delivery system, a shipping Tracking Number (TN), a Vehicle Identification Number (VIN) associated with the purchase, and an expected delivery date and an expected delivery location;
processing and registering by the shipping and tracking module, the purchase information including a request for package delivery to the target vehicle of the customer, where registering the purchase information in a first database of the cloud based provider site associated with the package-exchange-with-a-vehicle service;
setting up a package delivery operation by a security module in the first server associated with the package-exchange-with-a-vehicle service, the package delivery operation includes 1) delivery of the purchased products to the target vehicle of the customer, 2) opening and/or unlocking the target vehicle of the customer to ensure the one or more purchased products can be delivered, 3) ensuring the one or more purchased products have been delivered, and 4) after delivery, ensuring the target vehicle of the customer is closed and locked and delivery is complete;
creating, by a fourth module in the first server associated with the package-exchange-with-a-vehicle service, one or more database records for each completed delivery operation and storing the database records in the first database to keep track of deliveries, where cooperating with the shipping and tracking module to send a notice of package exchange to any of i) the second server of the first retail website, ii) the first client device of the customer, and iii) any combination of both;
implementing a first financial model on the database records by a compensation module in the first server associated with the package-exchange-with-a-vehicle service, where the first financial model selected from one or more financial models stored in the first database to calculate financial transactions between the package-exchange-with-a-vehicle service and the one or more retail websites;
implementing the package-exchange-with-a-vehicle service in software, hardware electronics, and any combination of both, and when one or more portions of the package exchange system including portions of the modules are implemented in software, and any software implemented on the first client device, then the software is tangibly stored in an executable format on one or more non-transitory storage mediums.

12. The method of claim 11, further including:
sending a delivery notice to a package exchange application resident in the first client device of the customer, the delivery notice including:
an expected date and time of delivery to the target vehicle of the customer, and
a notice of confirmation of completion of delivery; and
implementing a second financial model from the one or more financial models on the database records to calculate financial transactions between the package-exchange-with-a-vehicle service and the one or more package delivery systems.

13. The method of claim 11, further including for:
monitoring, by a GPS-based proximity module in the first server associated with the package-exchange service, a distance between a package delivery vehicle and the target vehicle of the customer through receiving current GPS coordinates of the package delivery vehicle and current GPS coordinates of the target vehicle of the customer, where the current GPS coordinates of the package delivery vehicle is received from the package delivery vehicle and the current GPS coordinates of the target vehicle is received from one of 1) an onboard actuation module installed in the target vehicle of the customer, or 2) the first client device of the customer;
wherein the GPS-based proximity module in cooperation with the security module further performing:
waking-up the on-board actuation module of the target vehicle of the customer while establishing a close proximity by a first threshold distance between the package delivery vehicle and the target vehicle of the customer, where the onboard actuation module includes 1) an onboard telematics module configured to communicate with a cloud based telematics provider, or ii) a dongle module having a Wi-Fi or cellular communication circuit;
giving an alert by the target vehicle of the customer while establishing a close proximity by a second threshold distance between the package delivery vehicle and the target vehicle of the customer;
unlocking a door including a trunk of the target vehicle of the customer;
exchanging at least one package between the package delivery vehicle and the target vehicle of the customer;
receiving a confirmation of the package exchange from the package delivery vehicle; and
locking the target vehicle of the customer after receiving the confirmation and establishing a fourth threshold distance.

14. The method of claim 13, further including
communicating by the security module in the first server associated with the package-exchange-with-a-vehicle service with a third server of a cloud based telematics provider to setup a package delivery operation through sending commands through the cloud based telematics provider to the onboard telematics module of the target vehicle of the customer, the package delivery operation includes sending commands for 1) giving an alert by the target vehicle of the customer, 2) opening the target vehicle of the customer and 3) ensuring the target vehicle of the customer is closed and locked after delivery;
receiving the current GPS coordinates of the target vehicle of the customer from the onboard telematics module of the target vehicle of the customer through the cloud based telematics provider; and
implementing a third financial model and calculating financial transactions between the package-exchange-with-a-vehicle service and one or more cloud based telematics providers.

15. The method of claim 14, wherein calculating the financial transactions between the package-exchange-with-a-vehicle service and the retail websites is based on a first series of fee agreements between a provider of the package-exchange-with-a-vehicle service and the retail websites, where the first series of fee agreements are one or combinations of 1) a subscription agreement with a minimum number of use and then per use charging, 2) a license agreement with unlimited use; and
wherein calculating financial transactions between the package-exchange-with-a-vehicle service and the cloud based telematics providers is based on a second series of fee agreements between the provider of the package-exchange-with-a-vehicle service and the cloud based telematics providers, where the second series of fee agreements are one or combinations of 1) a revenue share agreement, 2) a license agreement for unlimited use.

16. The method of claim 13, further including
receiving, by the security module in the first server associated with the package-exchange-with-a-vehicle service, at least two virtual verification keys, a first virtual verification key having a first shelf life from a second client device of the package delivery vehicle and a second virtual key having a second shelf life from the first client device of the customer;
using the first virtual verification key for authenticating communications received from the package delivery vehicle by the security module of the first server associated with the package-exchange-with-a-vehicle service, where the first virtual verification key is a public key selected from a pool of virtual keys in the first database associated with the package-exchange-with-a-vehicle service and provided through the first package delivery system to the second client device of the package delivery vehicle, the pool of virtual keys includes one or more public keys and associated private key;
using the second virtual verification key by the security module of the first server associated with the package-exchange-with-a-vehicle service for either of: 1) sending the second virtual verification key as a security token to the telematics provider, the telematics provider using the second virtual key to authenticate the customer and the target vehicle of the customer; or 2) using the second virtual verification key as a first rolling security key of a Body Control Module (BCM) of the target vehicle of the customer, where generating a next second rolling security key of the BCM from the first rolling security key by the security module of the first server associated with the package-exchange-with-a-vehicle service, and using the second rolling security key by a delivery person of the package delivery vehicle via a universal key fob simulator for sending command including lock and unlock commands to the BMC of the target vehicle of the customer; and
sending commands to the target vehicle of the customer within an overlap window of time between the first shelf life and the second shelf life.

17. The method of claim 11, further including
commanding the target vehicle of the customer through sending commands and rolling security keys of a Body Control Module of the security module from the first server associated with the package-exchange-with-a-vehicle service to the onboard actuation module in the target vehicle of the customer using Wi-Fi or cellular communication, and then the onboard actuation module transmitting RF signals including the rolling security keys and the commands to the Body Control Module of the target vehicle of the customer to perform mechanical operations including locking and unlocking of the target vehicle.

18. The method of claim 11, further including
sending commands and rolling security keys of a Body Control Module of the target vehicle of the customer from the security module in the first server associated with the package-exchange-with-a-vehicle service to a second client device of a package delivery vehicle, and then transmitting RF signals including the rolling security keys and the commands by an RF circuitry coupled to the second client device to the Body Control Module of the target vehicle of the customer to perform mechanical operations including locking and unlocking of the target vehicle.

19. The method of claim 11, wherein in response to receiving a customer verification request from the first retail website, the first module in the first server associated with the package-exchange-with-a-vehicle service performs either of: 1) providing a login screen for the customer of the first retail website, redirecting the shopping application resident on the first client device of the customer from the first retail website to the login screen of the cloud based provider site of the package-exchange-with-a-vehicle service to enter customer credentials corresponding to a customer's account of the package-exchange-with-a-vehicle service; or 2) receiving the customer credentials corresponding to the customer's account of the package-exchange-with-a-vehicle service from the second server of the first retail website;
verifying the customer based on the customer credentials including a username and a password and zero or more security questions; and
providing a verification response to the second server of the first retail website, the verification response includes a vehicle identification number of the target vehicle of the customer and information regarding services for package exchange available to the customer and a target vehicle associated with the customer.

20. A security system used by a cloud-based package-exchange-with-a-vehicle service to coordinate a secure package exchange, comprising:
one or more servers having one or more processors, one or more ports, and configured to cooperate with one or more databases in the system for cloud based package-exchange-with-a-vehicle service;
a security module running on the one or more processors is configured to coordinate the secure package exchange with an access module in a target vehicle by either directly sending an access control sequence and authentication code to a receiver module in a client device or sending an executable software package to be locally calculated by a processor on a client device to generate an appropriate access control sequence and authentication code to access a specific vehicle associated with a first user for the package exchange by remotely opening up or unlocking up the target vehicle;
where the security module is configured to receive, via one of the ports, a notification of a package exchange request for the first user either i) from a server of a first package delivery system or ii) from a server of a first merchant site, and where the security module is configured via a first port to receive credentials of the first user corresponding to an account of the first user stored in a database of the package-exchange-with-a-vehicle service and configured to verify the first user based on the credentials of the first user including a username, a password, and zero or more security questions, where after the verification, the security module is configured to send, via one of the ports, a verification response i) to the server of the first package delivery system, ii) to the server of the first merchant site, or iii) both;
where after the verification, the security module is configured to look up in the database in the cloud-based package-exchange-with-a-vehicle service for one or more contact information listings for the first user, and a first routine then is coded to create one or more notifications, including any of e-mail notifications, SMS text notifications, and mobile app notifications, to one or more client devices associated with the first user; where the one or more notifications request the first user to take action to verify that a package exchange with their target vehicle has indeed been requested by that first user;
where, a second routine in the security module is configured to, when there is more than one vehicle associated with the account of the first user, via one of the ports, to receive confirmation of which one of the vehicles associated with the account of the first user will be the target vehicle used for the package exchange with the first package delivery system, the received confirmation is from any of the following i) the client device of the user, ii) the server of the first merchant site, and iii) the server of the first package delivery system;
a first module in one of the servers associated with the package-exchange-with-a-vehicle service is configured to provide information regarding the services for a package exchange with a vehicle of a potential customer to the server of first merchant site prior to any purchase of a product, where the information regarding the services sent prior to any purchase of a product, is sent from the first server of the package-exchange-with-a-vehicle service, via one of the ports, to the server of the first merchant site to enable the first merchant site to present a button on a user interface of a shopping application resident on a first client device of the customer, the first client device is coupled to the first merchant website for purchasing products from the first merchant website, where the presented button is configured to enable the customer at a checkout point of the purchase from the first merchant site, to select an alternative package delivery option of delivering the one or more purchased products to the associated target vehicle of the customer;
a shipping and tracking module in the first server associated with the package-exchange-with-a-vehicle service is configured to communicate with the server of the first merchant site to receive purchase information after the checkout point and completion of the purchase by the customer; and
a compensation module in one of the servers of the package-exchange-with-a-vehicle service is configured to implement a first financial model from two or more financial models stored in the first database, the first financial model uses the database records to track and calculate financial transactions between the package-exchange-with-a-vehicle service and the one or more merchant websites, where the shipping and tracking module is configured to cooperate with the security module to set up the secure package exchange operation, and the compensation module is configured to implement one or more of the financial models that use database records from the package-exchange-with-a-vehicle service to calculate financial transactions between the package-exchange-with-a-vehicle service and the merchant sites.
